(19) United States
(12) Patent Application Publication
(10) Pub. No.: US 2025/0223787 A1
(43) Pub. Date: Jul. 10, 2025

(54) SHOWER CONTROL SYSTEM

(71) Applicant: Kohler Co., Kohler, WI (US)

(72) Inventors: Shaun Skelton, Sun Prairie, WI (US); Keith S. Ruh, Elkhart Lake, WI (US); Greta Knowles, Sheboygan, WI (US)

(73) Assignee: Kohler Co., Kohler, WI (US)

(21) Appl. No.: 18/965,256

(22) Filed: Dec. 2, 2024

Related U.S. Application Data
(60) Provisional application No. 63/618,212, filed on Jan. 5, 2024.

(51) Int. Cl. E03C 1/05; E03C 1/04

(52) U.S. Cl. CPC E03C 1/055; E03C 1/0408

(57) ABSTRACT

Systems, methods, and devices related to a shower system are described. The shower system includes a water subsystem and a controller in communication with the water subsystem. The water subsystem includes one or more electronic valves configured to control a flow rate and a temperature of water dispensed from one or more shower outlets within a shower enclosure. The controller is configured to record a sequence of user inputs to adjust operation of the water subsystem while operating the water subsystem to dispense the water from the one or more shower outlets in accordance with the sequence of user inputs. The controller is configured to display a new shower experience option corresponding to the sequence of user inputs on a user display device and operate the water subsystem in accordance with the sequence of user inputs responsive to a user selecting the new shower experience option.

### CROSS-REFERENCE TO RELATED APPLICATIONS

This application claims the benefit and priority to U.S. Provisional Application No. 63/618,212, filed Jan. 5, 2024, the entire disclosure of which is hereby incorporated by reference herein.

### BACKGROUND

The present disclosure relates generally to showers. More specifically, the present disclosure relates to shower control systems.

### SUMMARY

One embodiment of the present application relates to a shower system. The shower system includes a water subsystem and a controller in communication with the water subsystem. The water subsystem includes one or more electronic valves configured to control a flow rate and a temperature of water dispensed from one or more shower outlets within a shower enclosure. The controller is configured to record a sequence of user inputs to adjust operation of the water subsystem while operating the water subsystem to dispense the water from the one or more shower outlets in accordance with the sequence of user inputs. The controller is further configured to display a new shower experience option corresponding to the sequence of user inputs on a user display device and operate the water subsystem in accordance with the sequence of user inputs responsive to a user selecting the new shower experience option corresponding to the sequence of user inputs.

Another embodiment of the present application relates to a shower system. The shower system includes a water subsystem having one or more electronic valves configured to control a flow rate of water dispensed from a plurality of shower outlets within a shower enclosure. The shower system includes one or more sensors configured to acquire data indicative of the flow rate of water dispensed from the plurality of shower outlets and a controller in communication with the water subsystem and the one or more sensors. The controller is configured to determine maximum flow rates for each of the plurality of shower outlets based on the flow rate data. The controller is configured to convert a plurality of stored percentage flow rate values for the plurality of shower outlets into a plurality of absolute flow rate values for the plurality of shower outlets by scaling the percentage flow rate values to the maximum flow rates. The controller is further configured to operate the plurality of shower outlets in accordance with the absolute flow rate values when executing a stored shower experience.

Another embodiment of the present disclosure relates to a shower control system. The shower control system includes a control panel configured to receive user inputs regarding adjustment to operation of one or more components of a shower system, a plurality of sensors configured to measure operational data associated with the one or more components of the shower system, and a cloud integration controller communicatively coupled to the plurality of sensors. The cloud integration controller is configured to receive the operational data from the plurality of sensors, receive the user inputs from the control panel, and transmit, via a network, the user inputs and the operational data to a remote computing system. The cloud integration controller is further configured to receive error information from the remote computing system and cause a display of the shower system to present the error information.

### BRIEF DESCRIPTION OF THE DRAWINGS

FIG. 1 is a front view of a shower including a variety of output devices (e.g., shower outlets, speakers, lighting devices, and steam/aromatherapy outlets) and a control panel positioned within a shower enclosure to facilitate user control over the various output devices, according to an exemplary embodiment.

FIG. 2 is a block diagram of a shower control system including a central controller configured to monitor and control the shower output devices in the shower of FIG. 1, according to an exemplary embodiment.

FIG. 3 is a block diagram of another shower control system in which the controller of FIG. 2 is used to control a plurality of mixing valves, each of which affects the water dispensed by a different set of water outlets, according to an exemplary embodiment.

FIG. 4 is a is a block diagram illustrating the controller of FIG. 2 in greater detail, according to an exemplary embodiment.

FIG. 5 is a flow chart of a purge process which can be performed by the controller of FIG. 2, according to an exemplary embodiment.

FIG. 6 is a flow chart of a process for recording shower experiences which can be performed by the controller of FIG. 2, according to an exemplary embodiment.

FIG. 7 is a flow chart of a process for synchronizing water spray patterns, lighting, and audio which can be performed by the controller of FIG. 2, according to an exemplary embodiment.

FIG. 8 is a flow chart of a process for transmitting telemetric data for error detection and troubleshooting which can be performed by the controller of FIG. 2, according to exemplary embodiments.

FIG. 9 is a flow chart of a process of maximizing flow rate, which can be performed by the controller of FIG. 2, according to exemplary embodiments.

FIG. 10 is a front view of a control panel displaying a default home menu, according to exemplary embodiments.

FIG. 11 is a front view of a control panel displaying shower outlet options, according to exemplary embodiments.

FIG. 12 is a front view of a control panel displaying a steam room temperature setpoint, according to exemplary embodiments.

FIG. 13 is a front view of a control panel displaying a steam room warming countdown timer, according to exemplary embodiments.

FIG. 14 is a front view of a control panel displaying a steam room warming user interface showing the current steam room temperature, according to exemplary embodiments.

FIG. 15 is a front view of a control panel displaying a purge control user interface on which a user sets a desired water outlet temperature, according to exemplary embodiments.

FIG. 16 is a front view of a control panel displaying the current water temperature during the purge warming process of FIG. 5, according to exemplary embodiments.

FIG. 17 is a front view of a control panel displaying a menu of shower outlet options, according to exemplary embodiments.

FIG. 18 is a front view of a control panel displaying a selected rainhead shower outlet button and a deluge button, according to exemplary embodiments.

FIG. 19 is a front view of a control panel displaying the deluge button of FIG. 18 blinking to indicate a reservoir is filling, according to an exemplary embodiment.

FIG. 20 is a front view of a control panel displaying the deluge button of FIG. 18 selected to incrementally drains a reservoir while in deluge mode, according to an exemplary embodiment.

FIG. 21 is a front view of a control panel displaying a QR code for initial system setup, according to exemplary embodiments.

FIG. 22 is a front view of a control panel displaying a URL for initial system setup, according to exemplary embodiments.

FIG. 23 is an embedded setup webpage displayed on a mobile user device, according to exemplary embodiments.

FIG. 24 is an initial setup user interface, which can be generated by the controller of FIG. 2, displaying preferred unit system options, according to exemplary embodiments.

FIG. 25 is an initial setup user interface, which can be generated by the controller of FIG. 2, displaying an option for a user to select if they are located low water flow region, according to exemplary embodiments.

FIG. 26 is an initial setup user interface, which can be generated by the controller of FIG. 2, displaying a shower default selection user interface, according to exemplary embodiments.

FIG. 27 is GUI displayed on a mobile user device containing favorite preset shower experiences which can be generated by the controller of FIG. 2, according to exemplary embodiments.

FIG. 28 is a GUI, which can be generated by the controller of FIG. 2, of a selected favorite preset of FIG. 27, according to exemplary embodiments.

FIG. 29 is a menu of pre-programmed shower experience options, which can be generated by the controller of FIG. 2, displayed on a mobile user device, according to exemplary embodiments.

FIG. 30 is a selected pre-programmed shower experience of FIG. 29 displayed on a mobile user device, according to exemplary embodiments.

FIG. 31A is an optional update user interface displayed, which can be generated by the controller of FIG. 2 on a mobile user device, according to exemplary embodiments.

FIG. 31B is a required update user interface, which can be generated by the controller of FIG. 2, displayed on a mobile user device, according to exemplary embodiments.

FIG. 32 is a front view of a control panel displaying an update user interface, according to exemplary embodiments.

FIG. 33 is a front view of a control panel displaying a USB update file detection user interface, according to exemplary embodiments.

FIG. 34 is a front view of a control panel displaying an option to connect the shower control system to an app, according to exemplary embodiments.

FIG. 35 is a mobile app page that includes the details of a controller, according to exemplary embodiments.

FIG. 36 is a mobile app device settings page on which a user may view their water usage, according to exemplary embodiments.

FIG. 37 is a mobile app error log and diagnostic page, according to exemplary embodiments.

FIG. 38 is a mobile app page showing a remote control button that may be used to turn a shower on and off, according to exemplary embodiments.

FIG. 39 is a front view of a control panel showing water usage and duration reporting user interface, according to exemplary embodiments.

FIG. 40A is a mobile app page showing water usage reports, according to exemplary embodiments.

FIG. 40B is a mobile app page showing shower duration reports, according to exemplary embodiments.

FIG. 41A is a of graphical representation of shower experiences controlled by a controller, according to exemplary embodiments.

FIG. 41B is a of graphical representation of shower experiences controlled by a controller, according to exemplary embodiments.

FIG. 42 is a perspective view of a two-outlet mixing valve, according to exemplary embodiments.

FIG. 43 is a perspective view of a three-outlet mixing valve, according to exemplary embodiments.

FIG. 44 is a perspective view of a four-outlet mixing valve, according to exemplary embodiments.

FIG. 45 is a perspective view of a six-outlet mixing valve, according to exemplary embodiments.

### DETAILED DESCRIPTION

Referring generally to the FIGURES, a shower and a shower control system are shown, according to various exemplary embodiments. The shower includes a shower enclosure and several shower subsystems (i.e., a water subsystem, an audio subsystem, a steam subsystem, a lighting subsystem, an aromatherapy subsystem, etc.). Each of the shower subsystems has output devices (e.g., shower outlets, flow control valves, temperature control valves, solenoids associated with the valves, lighting devices, audio output systems, steam outlets, aromatherapy outlets, etc.) configured to provide a user of the shower with an enhanced showering experience.

The shower control system includes a control panel having an electronic display. The electronic display is configured to display graphical user interfaces for allowing user control of the various shower subsystems and/or shower output devices. A controller is in communication with the electronic display and causes the graphical user interfaces to be presented via the electronic display. In various embodiments, the controller may be integrated with the control panel, physically separate from the control panel, or partially integrated and partially separate from the control panel. The control panel may include a touch-sensitive panel overlaying the electronic display (e.g., a capacitive touch screen) as an input device configured to receive user input and provide the user input to the controller, according to exemplary embodiments. The control panel (e.g., via the controller) controls the various components of the shower in response to the user inputs (e.g., signals or data representing the user inputs) received at the user input devices.

A shower control system is provided for receiving and processing user inputs, displaying a graphical user interface on the electronic display, and controlling outputs of the various output devices. The shower control system advantageously includes software that causes the generation and display of intuitive graphical user interfaces for providing an intuitive and powerful control experience to the user. Settings and combinations of settings may be saved in the shower control system (e.g., a controller of the system) for later playback (e.g., execution) by a controller of the shower control system. Such playback or execution causes actuation, adjustment, or another state change of one or a plurality of the shower output devices.

In some embodiments, the shower control system is connected to a communications network (e.g., a LAN, WAN, the Internet, etc.). The network connection may allow a user to view and modify various configuration settings stored within a controller for the shower control system and to receive information from the controller (e.g., usage information, log data, etc.). In some embodiments, communications via the network are used to actively control the outputs from various devices (e.g., starting and stopping water flow, adjusting setpoints, turning on/off lighting, steam, audio, aromatherapy, etc.).

In some embodiments, the shower control system is configured to receive updates via the communications network. For example, the controller may be configured to receive firmware updates, software updates, configuration updates, or other updates from a remote server (e.g., from the system manufacturer) or other network data source (e.g., a networked user device). In various embodiments, the controller may be configured to check for and download updates periodically or may receive pushed updates from a remote data source when the updates become available. Advantageously, updating the controller via the network allows for new and improved shower experiences, user interfaces, and/or other features to be provided to multiple controllers in an automated manner. The controller can then install the updates to make the new and improved features available to a user. These and other features of the shower control system are described in greater detail below.

### Shower and Shower Control System

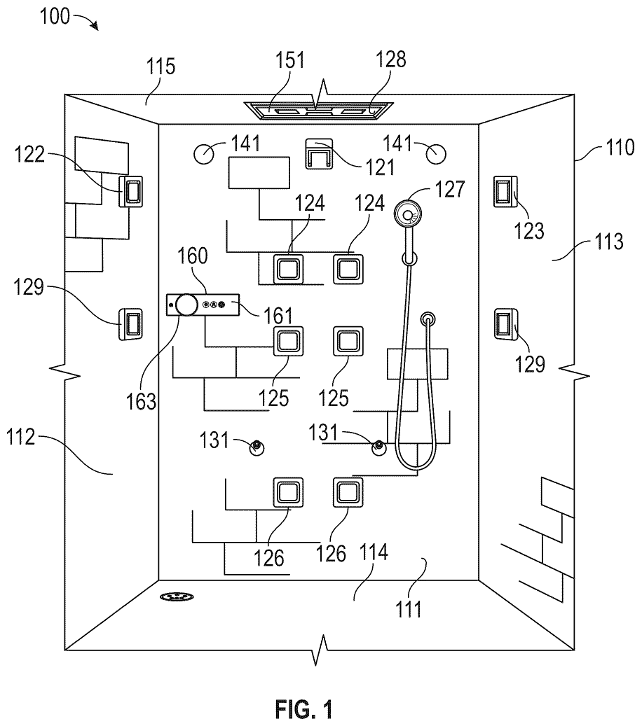

Referring now to FIG. 1, a shower 100 is shown, according to an exemplary embodiment. The shower 100 includes a shower enclosure 110 having a front wall 111, a left wall 112, a right wall 113, a floor 114, and a ceiling 115. An access door may permit entry by the user into the shower enclosure 110. The control systems and methods of the present disclosure may be used in combination with the shower 100 or any other shower having any shape or size of shower enclosure. For example, alternative shower enclosures may contain fewer or additional walls, be of varying sizes, contain other water outlets or lighting arrangements, or be otherwise configured.

The shower 100 includes a water subsystem having various water delivery devices (i.e., shower outlets) located within the shower enclosure 110. For example, the shower 100 is shown to include a front showerhead 121, a left showerhead 122, a right showerhead 123, an upper body spray 124, a middle body spray 125, a lower body spray 126, side body sprays 129, a handshower 127, and a rainhead 128. In various embodiments, the water subsystem or set of water delivery devices may include any number or combinations of water delivery devices. For example, in an alternative exemplary embodiment, the water subsystem may include a central body spray (e.g., a vertical column of shower outlets) in place of an upper body spray 124 and a middle body spray 125. In another exemplary embodiment, the left showerhead 122 and the right showerhead 123 may be located on the front wall 111. The shower outlets 121-129 may be located on any of the surfaces 111-114 and may include additional or fewer shower outlets in various embodiments.

The water subsystem may include one or more analog or digital valves. Each of the valves may be associated with one or more of the shower outlets 121-129 and may be configured to control the water temperature and/or flow rate of the water delivered by the associated shower outlet(s). Valves of the system may be configured to allow for an electronically controlled mixing of hot and cold water. Such mixing can allow control systems and methods described herein to achieve or approach certain target temperatures (i.e., temperature control). Valves of the system may also be configured to allow for electronically controlled or selected shower outlet water flow (i.e., flow rate control). The electronically controlled valves (e.g., solenoids for actuating the hydraulic valves) are controlled via control signals from one or more controllers of the shower control systems described throughout this disclosure.

In some embodiments, each of the shower outlets 121-129 is associated with a different mixing valve configured to control the water temperature and/or flow rate of the water dispensed from the corresponding shower outlet. For example, a mixing valve may be installed upstream of each of the shower outlets 121-129, combined with each of the shower outlets 121-129, or otherwise fluidly connected with each of the shower outlets 121-129. Each of the mixing valves may be independently controlled by a controller to allow for independent control of the temperatures and/or flow rates of the water dispensed from shower outlets 121-129. In other embodiments, a single mixing valve is used to control the temperature and/or flow rate of water provided to groups of the shower outlets 121-129 or all of the shower outlets 121-129.

In some embodiments, each of the valves is associated with a subset of the shower outlets 121-129. For example, each mixing valve may have a plurality of outlet ports (e.g., three outlet ports, six outlet ports, etc.), each of which is fluidly connected to one or more of the shower outlets 121-129. In other instances, one or more mixing valves may output water to a pipeline that includes several branches, each of which is fluidly connected to one or more of the shower outlets 121-129. A first mixing valve may control the temperature and/or flow rate of water provided to a first subset of the shower outlets 121-129, whereas a second mixing valve may control the temperature and/or flow rate of water provided to a second subset of the shower outlets 121-129. For example, a first mixing valve may control the temperature and/or flow rate of water provided to the shower outlets 121, 125, and 128, whereas a second mixing valve may control the temperature and/or flow rate of water provided to the shower outlets 122, 123, 124, 126, and 127. Advantageously, using multiple different mixing valves allows the water from different shower outlets to have different temperatures and/or flow rates. In various embodiments, any number of mixing valves may be used to define any number of temperature zones.

The water subsystem may be controlled via control signals from one or more controllers of the shower control systems described throughout this disclosure. For example, a controller may be configured to automatically operate the mixing valves to adjust the temperatures and/or flow rates of water provided to various sets of the shower outlets 121-129. The water subsystem may be automatically operated by the controller as part of a stored shower experience that dispenses water from the shower outlets 121-129 according to a predefined pattern of water temperatures and/or flow rates defined by the shower experience.

In some embodiments, the shower 100 includes a steam subsystem. The steam subsystem may include steam outlets 131 that receive steam from a steam generator in fluid communication with the steam outlets 131. The steam generator may be disposed between, and coupled via conduit (e.g., piping or tubing), to the steam outlets 131 and a water supply. The steam generator heats the water, turning it into steam that is then communicated into the shower enclosure 110 through the steam outlets 131. The steam subsystem may be controlled via control signals from one or more controllers of the shower control systems described throughout this disclosure and may be used to incorporate steam into the shower experiences.

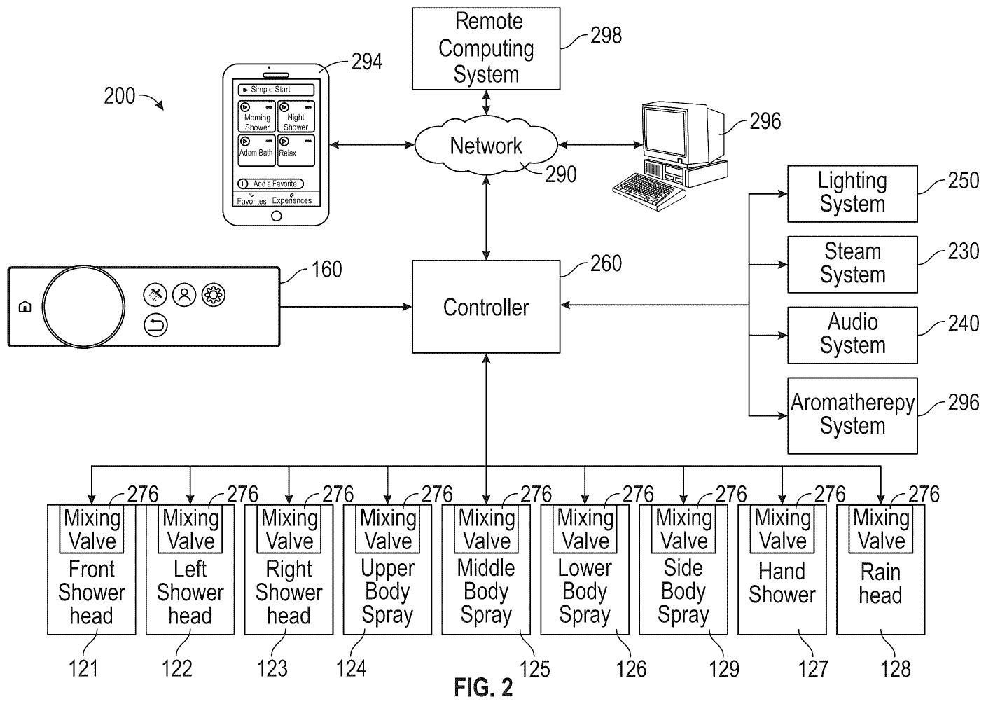

In some embodiments, the shower 100 includes an aromatherapy subsystem. The aromatherapy subsystem may be configured to dispense various aromas or scents (e.g., fragrant oils, essential oils, aromatic compounds, etc.) into the shower enclosure 110. The aromatherapy subsystem may include an aerial diffuser, heater, vaporizer, or other device configured to vaporize a stored aromatic substance and emit the aromatic vapor into the shower enclosure 110. In some embodiments, the aromatic vapor is combined with the steam emitted via the steam outlets 131. In other embodiments, the aromatic vapor is emitted via separate aromatherapy outlets 181 (shown in FIG. 2), which may be located within the shower enclosure 110 (e.g., anywhere along any of the walls 111-115). The aromatherapy subsystem may be configured to selectively vaporize and dispense any of a plurality of stored aromatic substances in response to a control signal from a user control panel and/or a controller. The aromatherapy subsystem may be controlled via control signals from one or more controllers of the shower control systems described throughout this disclosure and may be used to incorporate aromatherapy into the shower experiences.

In some embodiments, the shower 100 includes an audio subsystem. The audio subsystem includes speakers 141, an amplifier, and a media player. The amplifier, media player, and other components may be located proximate to or remote from the shower enclosure 110. The audio subsystem is configured to communicate sound into the shower enclosure 110. The audio subsystem (e.g., a media player thereof) may be controlled via control signals from one or more controllers of the shower control systems described throughout this disclosure and may be used to incorporate music or other audio effects into the shower experiences.

In some embodiments, the shower 100 includes a lighting subsystem. The lighting subsystem includes one or more lights 151, such as conventional light bulbs (e.g., incandescent, LED, fluorescent) or a plurality of colored lights configured for use as a lighted rain panel used for chromatherapy. In some embodiments, the lights 151 are integrated with a rainhead 128. The lighting subsystem is configured to selectively supply light into the shower enclosure 110. The lighting subsystem (e.g., particular switches for the lights, dimmers for the lights, etc.) may be controlled via control signals from one or more controllers of the shower control systems described throughout this disclosure and may be used to incorporate chromatherapy or other lighting effects into the shower experiences.

The shower 100 is shown having a plurality of the water outlets 121-129, the steam outlets 131, the speakers 141, the lights 151, and the aromatherapy outlets 181. Throughout this disclosure, these components may be referred to collectively as shower outlets, shower devices, shower components, shower output devices, or the like. It should be understood that these terms are not limited to water dispensing outlets and may include other types of outlets or devices configured to generate and/or output various substances or forms of energy into the shower enclosure 110 (e.g., water, steam, light, sound, vibrations, aromatic substances, etc.). Additionally, it is contemplated that the shower 100 may include any combination or subset of the shower subsystems and/or shower output devices described with reference to FIG. 1. For example, in some embodiments, the shower 100 may include only a subset of the shower outlets 121-129. As another example, in some embodiments, the shower 100 may include the water subsystem and one or more of the steam subsystem, the audio subsystem, the aromatherapy subsystem, and the lighting subsystem. All such variants are within the teachings of the present disclosure.

Still referring to FIG. 1, the shower 100 is shown to include a control panel 160. In some embodiments, the control panel 160 is configured to receive user inputs for controlling the shower subsystems and for communicating settings and status information of the shower subsystems to a user. The control panel 160 generally includes a housing and an electronic display 161 (e.g., an LCD panel). The housing includes various attachment points (e.g., brackets, fasteners, portions for receiving screw heads, etc.) for mounting control panel 160 within the shower enclosure 110. The housing also provides a waterproof casing to protect an electronic display 161 and associated internal electronic components from moisture. A touch-sensitive panel (e.g., a capacitive touch panel) may also be provided on the housing for receiving user inputs. A portion of the touch-sensitive panel may overlay the electronic display 161 to provide a touchscreen interface. The electronic display 161 can be caused to display graphical user interfaces (GUIs) and to receive user inputs via the touch screen interface.

The control panel 160 may be configured to display a graphical user interface via an electronic display 161 and to receive user input via a touch-sensitive panel 163 and/or buttons. The control panel 160 may include a communications interface (e.g., a wired or wireless interface) for communicating with the controller 260 and/or other systems or devices. The control panel 160 may facilitate user interaction with shower control system 200 by receiving and communicating user inputs to the controller 260 and displaying information to a user. In various embodiments, the controller 260 may be a component of the control panel 160 or may be implemented as a separate component.

The control panel 160 is shown to include an electronic display 161. In some embodiments, an electronic display 161 is a liquid crystal display (LCD). According to other exemplary embodiments, the electronic display 161 may use other display technologies particularly suited or adapted for use in a wet environment. The electronic display 161 may be positioned behind a touch-sensitive panel 163 and configured to operate as a touchscreen display. For example, the electronic display 161 may graphically display information and soft keys (i.e., graphics or icons) configured to be selected by a user or otherwise receive user input. The soft keys may depict, for example, a virtual button, slider, dial, switch, keypad, or other graphic or icon. The control panel 160 may be configured to receive user inputs (e.g., when the user touches or presses one of the soft keys) or performs a gesture relative to a touch-sensitive panel 163 (e.g., a swiping motion). In some embodiments, touch-sensitive panel 163 employs resistive touch or capacitive touch-sensitive technology (e.g., capacitive glass). In other embodiments, the touch-sensitive panel 163 may use other touch-sensitive technologies as may be applied in wet environments or may use touch-sensitive technology in combination with hard keys (i.e., physical buttons) located elsewhere on the control panel 160.

Referring now to FIG. 2, a block diagram illustrating a shower control system 200 is shown, according to an exemplary embodiment. The shower control system 200 may be used to monitor and control a plurality of water delivery devices (e.g., the shower outlets 121-129) as well as other controllable devices that may be used therewith (e.g., the steam outlets 131, the speakers 141, the lights 151). In some embodiments, the shower control system 200 is used to monitor and control the shower 100. For example, the shower control system 200 is shown to include a plurality of mixing valves 276, each of which is associated with one of the shower outlets 121-129. Each mixing valve 276 may be configured to affect the temperature and/or flow rate of the water dispensed from the corresponding shower outlet. In some embodiments, the mixing valves 276 are the same or similar to the mixing valves described in U.S. patent application Ser. No. 14/693,447, filed Apr. 22, 2015, the entire disclosure of which is incorporated by reference herein.

The mixing valves 276 may communicate with the controller 260 configured to monitor and control the mixing valves 276. For example, the mixing valves 276 may receive a control signal from the controller 260 that causes the mixing valves 276 to variably open or close to achieve a target water temperature and/or flow rate. In some embodiments, the mixing valves 276 include temperature sensors and/or flow rate sensors configured to measure the temperature and/or flow rate of the water dispensed by each of the mixing valves 276. In other embodiments, the sensors may be integrated with the shower outlets 121-129 or otherwise located in the shower control system 200. The sensors may provide feedback to the controller 260 regarding the temperatures and/or flow rates of the water dispensed by each of the mixing valves 276. The controller 260 may use the feedback from the sensors in conjunction with one or more temperature and/or flow rate setpoints to determine an appropriate control signal for each of the mixing valves 276. The communications between the mixing valves 276, the controller 260, and the sensors may be wired or wireless, and may use any of a variety of communications protocols.

The shower control system 200 is shown to include a lighting system 250, a steam system 230, an audio system 240, and an aromatherapy system 280. For example, the lighting system 250 may include one or more lights 151 configured to selectively supply light into the shower enclosure 110 (e.g., chromatherapy lights, ambient lights, rainhead lights, etc.). The lighting system 250 may also include various lights or lighting fixtures located in proximity to the shower enclosure 110 (e.g., within the same room or zone) or separate from the shower enclosure 110 (e.g., in a separate room or zone). The steam system 230 may include one or more steam generators configured to supply steam to the steam outlets 131 within the shower enclosure 110 and/or to other steam output devices. The audio system 240 may include a media player, an amplifier, and/or speakers. The speakers may be located within the shower enclosure 110 (e.g., the speakers 141) or otherwise located in proximity to the shower enclosure 110 or in a different room or zone. The aromatherapy system 280 may include an aerial diffuser, heater, vaporizer, or other device configured to vaporize a stored aromatic substance and emit the aromatic vapor into the shower enclosure 110. In some embodiments, the aromatic vapor is combined with the steam emitted via the steam outlets 131.

The lighting system 250, the steam system 230, the audio system 240, and the aromatherapy system 280 may communicate with the controller 260 via a wired or wireless communications link. The controller 260 may provide control signals to the lighting system 250, the steam system 230, the audio system 240, and the aromatherapy system 280 to control the output devices thereof (e.g., lights, steam outlets, speakers, aerial diffusers, etc.). In various embodiments, the controller 260 may communicate directly with the output devices of the systems 230-280 or with one or more intermediate controllers (e.g., a lighting controller, a steam controller, a music controller, etc.) configured to control the output devices of one or more of the systems 230-280.

In some embodiments, the controller 260 communicates with control panel 160 via a wired or wireless communications link. The controller 260 may be configured to receive and process user inputs from the control panel 160 and to control the shower outlets 121-129, the lighting system 250, the steam system 230, the audio system 240, and/or the aromatherapy system 280 in accordance with the user inputs. For example, the control panel 160 may present a user interface that allows a user to view and modify setpoints for the mixing valves 276 (e.g., temperature setpoints, flow rate setpoints, etc.), to initiate or stop water flow from the shower outlets 121-129 (e.g., individually or as one or more groups), to run a predefined sequence of water outputs from the shower outlets 121-129, and/or to otherwise interact with or control the shower outlets 121-129.

The control panel 160 and the controller 260 may facilitate user interactions with the lighting system 250, the steam system 230, the audio system 240, and the aromatherapy system 280. For example, a user can provide inputs via the control panel 160 to turn on or off lighting, initiate a chromotherapy sequence, or otherwise monitor and the control lighting system 250. The user can provide inputs via the control panel 160 to view and modify steam temperature setpoints, start or stop steam from the steam outlets 131, or otherwise monitor and the control steam system 230. The user can provide inputs via the control panel 160 start or stop playback from the speakers 141, select an audio source, increase or decrease audio volume, or otherwise monitor and the control audio system 240. The user can provide inputs via the control panel 160 to view and modify aromatherapy settings, start or stop aromatherapy outputs, or otherwise monitor and control the aromatherapy system 280.

In some embodiments, the control panel 160 provides a user interface that allows a user to select and initiate a shower experience. The shower experience may automatically operate one or more of the mixing valves 276, the lighting system 250, the steam system 230, the audio system 240, and the aromatherapy system 280 using a predefined sequence of outputs to provide a multi-sensory user experience. Several exemplary shower experiences which may be provided by the shower control system 200 are described in detail in U.S. Pat. No. 10,626,583, filed Jan. 1, 2015, the entire disclosure of which is incorporated by reference herein.

In some embodiments, the shower control system 200 includes multiple control panels 160. Each of the control panels 160 may be disposed at a different location (e.g., in the shower 100, the outside shower 100, in a different shower, etc.) for facilitating user interaction with the shower control system 200 at multiple different locations. Each control panel 160 may be associated with one or more discrete showers that can be controlled by the shower control system 200. For example, the showers may be located in different rooms within the same house, hotel, apartment complex, hospital, or the like. An instance of the control panel 160 may be located proximate to each of the showers to allow user control over the corresponding shower and devices thereof (e.g., the mixing valves 276, the lighting system 250, the steam system 230, the audio system 240, etc.). For example, a control panel 160 within a particular hotel room may allow a user to control the devices within that hotel room.

In some embodiments, each instance of the control panel 160 is associated with a corresponding instance of the controller 260. For example, one instance of the controller 260 may control the devices within a particular room, whereas another instance of the controller 260 may control the devices within another room. In other embodiments, the controller 260 is a centralized controller that receives and processes inputs from multiple control panels 160. A centralized controller 260 may control the devices within multiple different rooms or zones based on the user inputs provided via the control panel(s) 160 for that room or zone.

In various embodiments, the controller 260 may be integrated with one or more of the control panels 160 or separate from control panels 160. The controller 260 may receive input from the control panels 160 and may control the user interfaces provided via electronic display 161. The controller 260 processes user inputs received at the control panels 160 (e.g., user inputs received via a touchscreen, buttons, switches, or other user input devices of the control panel 160) and provides control outputs to the mixing valves 276, the lighting system 250, the steam system 230, and the audio system 240 based on the user inputs.

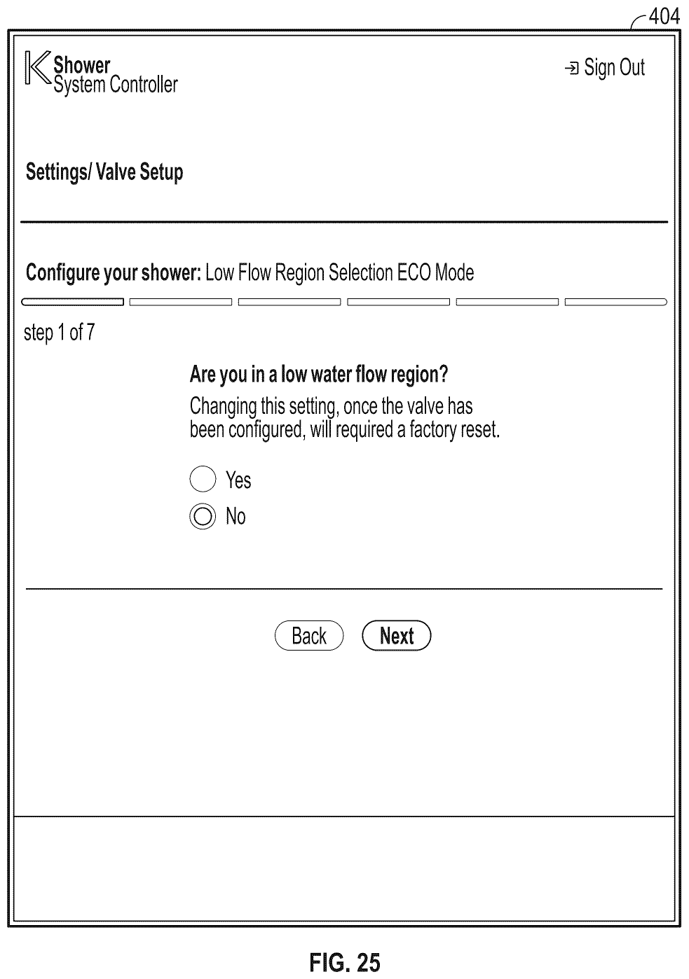

In some embodiments, the controller 260 is connected to a network 290 (e.g., a LAN, a WAN, a Wi-Fi network, the Internet, a cellular network, etc.) configured to facilitate interactions with controller 260. For example, a user can communicate with the controller 260 via the network 290 using any of a variety of the mobile devices 294 (e.g., a laptop computer, a tablet, a smart phone, etc.) or the non-mobile devices 296 (e.g., a desktop computer, a workstation, a server, etc.). GUIs presented to the mobile devices 294 are shown in greater detail in FIGS. 25-29. Communications via the network 290 may allow a user to view and modify various configuration settings stored within the controller 260 (e.g., valve configuration settings, network configuration settings, water outlet configuration settings, purge cycles, etc.) and to receive information from the controller 260 (e.g., usage information, log data, etc.). In some embodiments, communications via the network 290 can be used to actively control the outputs from various devices (e.g., starting and stopping water flow, adjusting setpoints, turning on/off lighting, steam, audio, aromatherapy, etc.).

In some embodiments, the user interface presented via the control panel 160 also allows the user to view and modify configuration settings, and to retrieve information from the controller 260. The user interactivity options available via control panel 160 may include some or all of the operations that can be performed via the network 290. In some embodiments, the user interactivity options available via the control panel 160 are limited to a subset of the operations available via the network 290. For example, a system administrator may configure each control panel 160 to allow a user to control a set of devices without allowing the user to modify configuration settings. The options available to a user via the control panel 160 may be defined by configuration parameters stored within the controller 260, which can be modified via the network 290.

In some embodiments, the controller 260 is configured to receive updates via the network 290. For example, the controller 260 may be configured to receive firmware updates, software updates, configuration updates, or other updates from a remote server (e.g., from the system manufacturer) or other network data source (e.g., a networked user device). In various embodiments, the controller 260 may be configured to check for and download updates periodically or may receive pushed updates from a remote data source, shown as the remote computing system 298, when the updates become available. Advantageously, updating the controller 260 via the network 290 allows for new and improved shower experiences, user interfaces, and/or other features to be provided to multiple controllers 260 in an automated manner. The controller 260 can then install the updates to make the new and improved features available to a user.

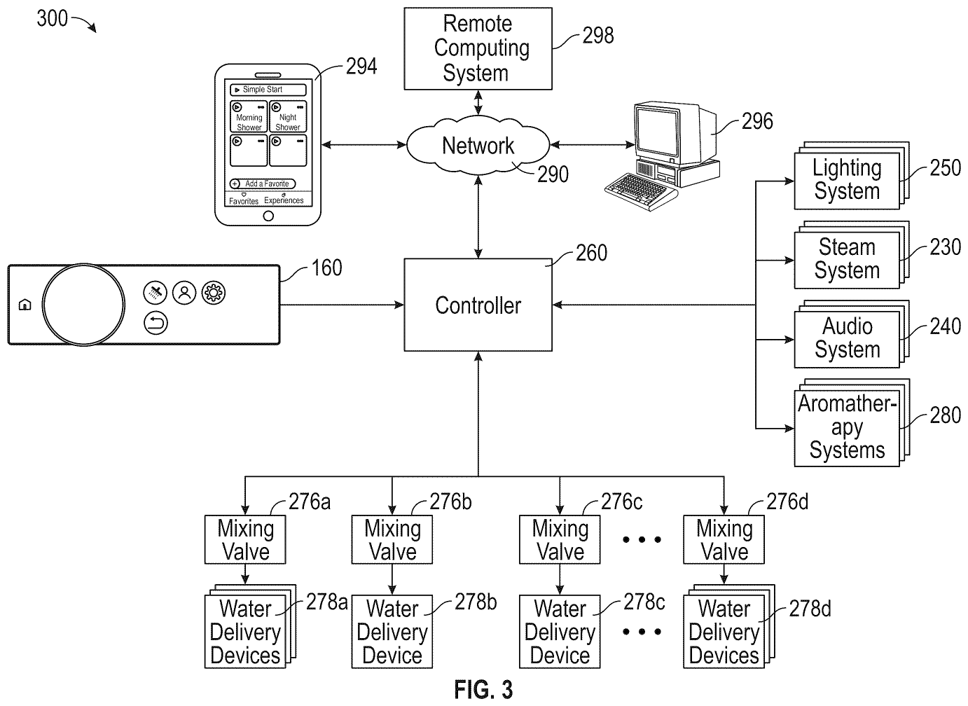

Referring now to FIG. 3, a block diagram of another shower control system 300 is shown, according to an exemplary embodiment. A shower control system 300 is shown to include many of the same components as the shower control system 200. However, in the shower control system 300, each mixing valve 276a-276d is associated with one or more water delivery devices 278a-278d rather than a specific shower outlet. Each mixing valve 276a-276d may be an instance of the mixing valve 276, as described with reference to FIG. 2. The mixing valves 276a and 276d are shown providing water to a plurality of the water delivery devices 278a and 278d, respectively. The water delivery devices 278a and 278d may be sets of shower outlets, faucets, bathtub taps, etc. within the same temperature group. The mixing valves 276b and 276c are shown providing water to a single water delivery device 278b and 278c, respectively. The water delivery devices 278b and 278c may be individual shower outlets, faucets, bathtub taps, etc.

In some embodiments, the mixing valves 276a-276d are located within the same general area (e.g., behind the wall of a shower enclosure, within a bathroom, etc.) and configured to provide water to various water delivery devices in that area. For example, the mixing valves 276a-276d may be configured to provide water to various shower outlets within the same shower enclosure, as described with reference to FIGS. 1 and 2. In other embodiments, the mixing valves 276a-276d are located in different physical areas (e.g., within different hotel rooms, apartments, hospital rooms, etc.) and configured to provide water to water delivery devices located in each of the different physical areas. For example, the mixing valves 276a-276b may be located within a first hotel room and configured to provide water to the water delivery devices 278a-278b within the first hotel room, whereas the mixing valves 276c-276d may be located within a second hotel room and configured to provide water to water delivery devices 278c-278d within the second hotel room.

Each set of the water delivery devices 278a-278d may be associated with one or more controllers 260 configured to monitor and control the water delivery devices 278a-278d. In various embodiments, the controller 260 may be a centralized controller for all of water delivery devices 278a-278d or a local controller for a subset of the water delivery devices 278a-278d (e.g., a set of the water delivery devices 278a-278d located within the same room or zone). Controller(s) 260 may also be configured to monitor and control one or more lighting systems 250, steam systems 230, audio systems 240, and/or aromatherapy systems 280, as described with reference to FIG. 2. One or more control panels 160 may be provided to facilitate user interaction with the controller(s) 260 and the controllable devices associated therewith.

In some embodiments, the shower control system 300 allows for the programming of a single water delivery device or multiple water delivery devices and/or the controller(s) 260 associated therewith via the network 290. This is particularly advantageous in that it allows for the programming of one or more water delivery devices and/or controllers 260 individually from a single location (e.g., via a single communication device such as the mobile device 294 or the non-mobile device 296). Multiple control systems 300 and the components thereof can be programmed and updated via the network 290 from centralized location (e.g., from a user device and/or a remote server), as described with reference to FIG. 2.

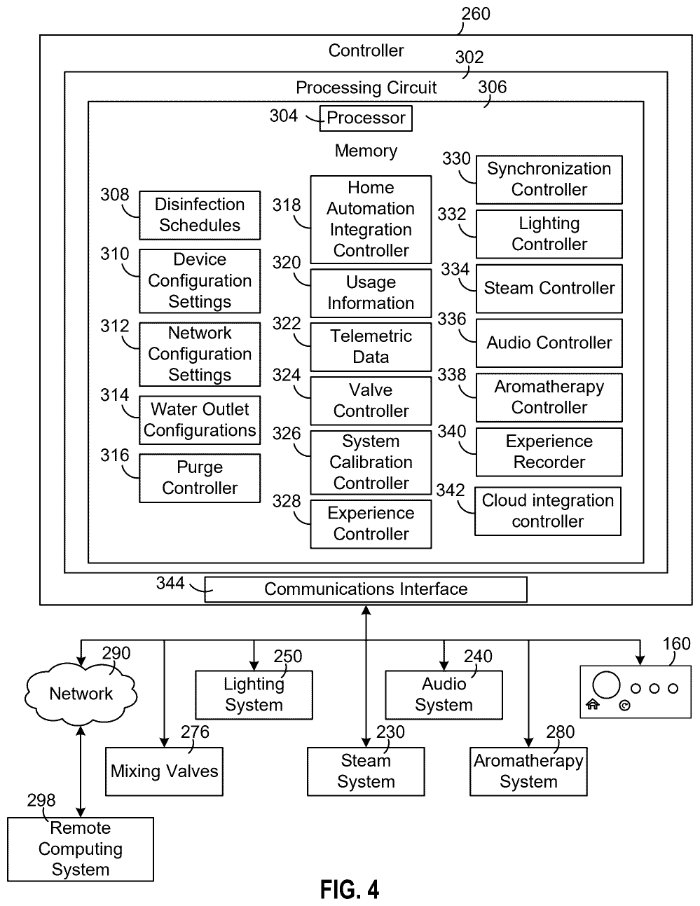

Referring now to FIG. 4, a block diagram illustrating the controller 260 in greater detail is shown, according to an exemplary embodiment. The controller 260 may be a central controller for a plurality of rooms or zones (e.g., a building management system controller in a hospital, residential building, office building, etc.) or a local controller for a particular room or zone (e.g., a controller for a particular shower area). The controller 260 is shown to include a communications interface 344 and a processing circuit 302.

The controller 260 is shown to include the communications interface 344, a processor 304, and a memory 306. The processor 304 may be a general purpose or specific purpose processor, an application specific integrated circuit (ASIC), one or more programmable logic controllers (PLCs), one or more field programmable gate arrays (FPGAs), a group of processing components, or other suitable processing components. Processor 304 is configured to execute computer code or instructions stored in the memory 306 or received from other computer readable media (e.g., embedded flash memory, local hard disk storage, local ROM, network storage, a remote server, etc.).

The memory 306 may include one or more devices (e.g., memory units, memory devices, storage devices, etc.) for storing data and/or computer code for completing and/or facilitating the various processes described in the present disclosure. The memory 306 may include random access memory (RAM), read-only memory (ROM), hard drive storage, temporary storage, non-volatile memory, flash memory, optical memory, or any other suitable memory for storing software objects and/or computer instructions. The memory 306 may include database components, object code components, script components, or any other type of information structure for supporting the various activities and information structures described in the present disclosure. The memory 306 may be communicably connected to the processor 304 via a processing circuit and may include computer code for executing (e.g., by the processor 304) one or more processes described herein. For example, the memory 306 may include graphics, web pages, HTML files, XML files, script code, shower configuration files, or other resources for use in generating graphical user interfaces for display and/or for use in interpreting user interface inputs to make command, control, or communication decisions.

The communications interface 344 may include wired or wireless communications interfaces (e.g., jacks, antennas, transmitters, receivers, transceivers, wire terminals, etc.) for conducting electronic data communications with various systems or devices. For example, the communications interface 344 is may be used to communicate with the network 290, the mixing valves 276, the lighting system 250, the steam system 230, the audio system 240, and/or the control panel 160. Communications via the communications interface 344 may be direct (e.g., local wired or wireless communications), or via communications the network 290 (e.g., a LAN, WAN, the Internet, a cellular network, etc.). For example, communications interface 344 may include an Ethernet card and port for sending and receiving data via an Ethernet-based communications link or network. In another exemplary embodiment, the communications interface 344 can include a Wi-Fi transceiver for communicating via a wireless communications network or Wi-Fi direct communications. In another exemplary embodiment, the communications interface 344 may include cellular or mobile phone communications transceivers, a power line communications interface, and/or any other type of wired or wireless communications hardware.

A processing circuit 302 is shown to include a processor 304 and a memory 306. The processor 304 can be implemented as a general purpose processor, an application specific integrated circuit (ASIC), one or more field programmable gate arrays (FPGAs), a group of processing components, or other suitable electronic processing components. The memory 306 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. The memory 306 may be or include volatile memory or non-volatile memory, and may include database components, object code components, script components, or any other type of information structure for supporting the various activities and information structures described in the present application. According to an exemplary embodiment, the memory 306 is communicably connected to the processor 304 via the processing circuit 302 and includes computer code for executing (e.g., by the processing circuit 302 and/or the processor 304) one or more processes described herein.

Still referring to FIG. 4, the memory 306 is shown to include a disinfection schedules 308. The disinfection schedules 308 may include a thermal disinfection schedule and/or an electrical disinfection schedule for one or more water delivery devices. Thermal disinfection may be accomplished by controlling a heating element located within a mixing valve. The heating element can be controlled to heat the valve such that the water contained within the valve acts as a disinfectant for at least a portion of the valve. Programmable features/settings associated with thermal disinfection include the target water temperature(s), disinfection timeout period, disinfection warm-up time, and total disinfection time. Programmable features/settings associated with electrical disinfection include disinfection frequency time, disinfection activation time, and disinfection timeout period. Disinfection schedules 308 can be programmed by a user via the network 290 or the control panel 160 or received as part of a packaged update from the remote computing system 298.

Still referring to FIG. 4, the memory 306 is shown to include device configuration settings 310. The device configuration settings 310 may include programmable features/settings associated with the various devices controlled by the controller 260 such as mixing valves 276, the lighting system 250, the steam system 230, the audio system 240, the aromatherapy system 280, etc. For example, device configuration settings 310 may include water set point temperatures, modes of operation (e.g., full cold water mode), default flow rate, flow rate change increments, timeout duration, run time, reaction time, blocking time, and other similar features for the mixing valves 276. The device configuration settings 310 may also include configuration settings for the lighting system 250, steam system 230, the audio system 240, and/or the aromatherapy system 280. In some embodiments, the device configuration settings 310 include shower experiences defining programmed sequences of outputs from the output devices. The device configuration settings 310 can be programmed by a user via the network 290 or the control panel 160 or received as part of a packaged update from a remote data source. For example, when a user or an installer adjusts any one of the above settings via the control panel 160 or the user devices 294-296, the changed information may be communicated to the controller 260 via the communications interface 344 and stored in the memory 306.

The memory 306 is shown to include network configuration settings 312. Network configuration settings 312 may define the types of communications used by the controller 260 (e.g., infrared, Wi-Fi, Ethernet, USB, etc.) and/or the network locations of various external components with which the controller 260 communicates. For example, the network configuration settings 312 may specify a wireless or the wired network 290 to which the controller 260 is connected (e.g., a LAN), and may include any network information (e.g., SSID, passwords, network key, authentication type, etc.) necessary to connect to the network 290. Network configuration settings 312 may also define whether the controller 260 is set to receive updates via the network 290 from a networked data source, and may specify the network location (e.g., URL, IP address, etc.) of the networked data source. Network configuration settings can be programmed by a user via the network 290 or the control panel 160 or received as part of a packaged update from a remote data source.

Still referring to FIG. 4, the memory 306 is shown to include a water outlet configuration 314. The water outlet configuration 314 may store data describing the particular configuration of the water delivery devices controlled by the controller 260. For example, the water outlet configuration 314 may define which of the water delivery devices are connected to the same valve, which of the water delivery devices are within the same control group (i.e., groups of devices that can be controlled together), the locations of the water delivery devices (e.g., within a particular room or zone of a facility), and/or any other information relating to the configuration of the water outlets. The water outlet configuration 314 can be programmed by a user via the network 290 or the control panel 160 or received as part of a packaged update from a remote data source.

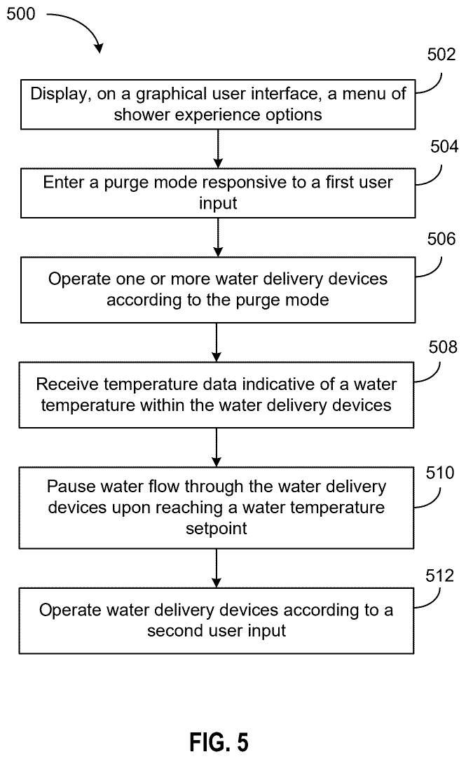

Memory 306 is shown to include a purge controller 316 that causes the shower to initiate a purge cycle. The purge controller 316 may store data relating to a purge of one or more water delivery devices. The purge feature allows shower control system 200 to achieve a target water temperature at an expedited rate by rapidly purging water from the inlet pipes leading into the system. The purge feature may be useful, for example, when shower 100 is initially turned on to purge water that has lost its heat from the hot water inlet line. If the purge feature is enabled (e.g., by a user input on the control panel 160) the purge controller may activate all of shower outlets 121-129 until a target temperature is reached. Upon reaching the target temperature, the purge controller 316 may pause activation of the shower outlets 121-129 until receiving a second user input to begin a shower. This concept is explored in greater detail with regards to FIG. 5.

Programmable features/settings associated with a purge controller 316 of one or the water delivery devices 121-128 may include the type of purge (e.g., standard, standard oscillation, smart, and smart oscillation), frequency time, purge activation time, purge duration, purge temperature, and purge warm-up time. Programmable features/settings associated with a cold purge cycle of one or water delivery devices includes the type of cold purge (e.g., standard, standard oscillation, smart, smart oscillation, etc.), frequency time, purge activation time, purge duration, purge temperature, and full cold water pre-purge time. Purge preferences can be programmed into purge controller 316 by a user via the network 290 or control panel 160 or received as part of a packaged update from the remote computing system 298.

Still referring to FIG. 4, the memory 306 is shown to include a home automation integration controller 318, according to an exemplary embodiment. Home automation integration controller 318 may be communicatively coupled with a home controller (e.g. Amazon Alexa, Google Home/Nest, Home Assistant, etc.). Voice commands may be transmitted from the automated home controller to home automation integration controller 318, which thereby transmits signals to operate the controller(s) and/or devices pertinent to a user's voice command. In this way, a user may order a purge or specific shower experience using voice control. By way of example, the home automation integration controller 318 receives voice commands from the home controller and may perform natural language processing convert the voice commands into a machine-readable format. The home automation integration controller 318 may generate and transmit control signals via the communications interface 344 to corresponding devices within the shower 100 (e.g., the mixing valves 276, water delivery devices 121-127, lighting system 250, steam system 230, audio system 240, aromatherapy system 280, etc.).

Memory 306 is shown to include usage information 320 and telemetric data 322. Telemetric data 322 may include parameters such as water temperature, flow rates, valve positions, and power usage of various shower system components. Telemetric data 322 may also include connectivity status between the control panel, the main controller, and other connected devices. As an example, telemetric data 322 may note a connection status between the controller 260 and the network 290. In some embodiments, the controller 260 is configured to log usage information 320 relating to events such as water usage, purge cycles, and thermal disinfection events. The data may be stored in the memory 306 and transmitted to an external device (e.g., the user devices 294, 296, the control panel 160) for analysis and reference. According to an exemplary embodiment, the data relating to the above noted events is automatically logged by the shower controller 260 for up to a 12 month period. This is advantageous in that it allows for the monitoring and analysis of one or more water delivery devices to determine future cost allocation associated with water usage, to analyze previous usage trends, to determine optimized maintenance schedules, and to predict future water usage. The usage information 320 and the telemetric data 322 may be automatically stored in the memory 306 during operation. Controller 260 may be configured to retrieve the usage information 320 and the telemetric data 322 from the memory 306 (e.g., periodically and/or upon request from an external system or device) and send the usage information 320 and the telemetric data 322 to an external system or device via communications interface 344.

In some embodiments, the usage information 320 and the telemetric data 322 are transmitted to a cloud integration controller 342. The cloud integration controller 342 is communicatively coupled to the remote computing system 298 via the network 290. In this way, the cloud integration controller 342 may gather and transmit user data (e.g., a user profile, user preferences, etc.), usage information 320, and/or the telemetric data 322 to the remote computing system 298. The cloud integration controller may evaluate connectivity to confirm active links between devices, for example, between the control panel 160 and controller 260, and transmit connectivity status updates to the remote computing system 298.

The remote computing system 298, may be associated with the provider or manufacturer of the shower system, according to exemplary embodiments. The remote computing system 298 is configured to store a database of thresholds and error codes corresponding to a range of sensor data patterns. These thresholds allow the remote computing system 298 to evaluate incoming data for discrepancies that may indicate operational issues. Upon receiving the data from cloud integration controller 342, the remote computing system 298 compares it against stored thresholds, identifying deviations that match patterns associated with error conditions. For example, if temperature data from a sensor falls outside the expected range for a user's settings, the remote computing system 298 may assign an error code to the corresponding inlet valve. The error code and corresponding component may be transmitted to the cloud integration controller 342, which, in turn, may display a user interface that includes error information on a user device (e.g., the control panel 160, the mobile user device 294, etc.) Advantageously this may aid users in troubleshooting or fixing systemic issues within their shower. Additionally, this allows regular updates to be transmitted from the remote computing system 298 to the cloud integration controller 342.

In some embodiments, the controller 260 may store a local database of error codes and thresholds, allowing the controller 260 to detect error conditions based on comparisons of sensor data to stored thresholds. If a detected condition aligns with an error code in its database, the controller 260 can assign and log the error, which it may report to the remote computing system 298 or display directly on a user interface, such as the control panel 160 or mobile device 294.

Still referring to FIG. 4, memory 306 is shown to include a valve controller 324. The valve controller 324 may be configured to monitor and control the mixing valves 276. Monitoring a mixing valve may include receiving feedback signals indicating the current state of the valves and/or attributes of the water dispensed by the valves. Controlling the mixing valves 276 may include generating control signals for the mixing valves 276. The control signals may instruct one or more mixing valves 276 to open, close, or adjust the amount of hot water and/or cold water provided through the valve in order to adjust the temperature and/or flow rate of the water dispensed from each of the mixing valves 276. In some embodiments, valve controller 324 is configured to control each of mixing valves 276 independently.

Memory 306 is shown to include a system calibration controller 326. The system calibration controller 326 may perform a system calibration process on initial setup of a shower system (e.g., the shower control system 200). In some examples, a user may recalibrate their shower system on demand (e.g., by an input on the control panel 160, by an input on an associated mobile app, etc.) to cause the system calibration controller 326 to perform the calibration process. Based on the measured mixing valve flow rates, the system calibration controller 326 may determine the maximum flow rate of each shower outlet (e.g. water delivery devices 121-129) in the shower 100. The system calibration controller 326 may determine the maximum flow rate of each combination of the water delivery devices 121-129 possible within a given shower system. The system calibration controller 326 may also determine maximum flow rates based on the number of active shower outlets. If the user activates additional shower outlets or deactivates shower outlets during a shower experience, the maximum flow rate of each active shower outlet is recalculated. In this way, the system calibration controller 326 determines a maximum range and scale of flow rates dynamically.

In some examples, the system calibration controller 326 determines the maximum flow rate of each water delivery device 121-129 by measuring the flow rates output by each mixing valve 276. The measured flow rates may be used as inputs for a data table that outputs a maximum flow rate for the particular mixing valve 276 and shower system. For example, if a user sets a flow rate percentage for a particular shower outlet (e.g., 50%), the system calibration controller 326 would receive a measured flow rate delivered by the corresponding mixing valve 276. However, the physical position of the valve (e.g., being open 50%) does not necessarily correlate to 50% of the maximum flow rate (e.g., due to variations in water pressure, plumbing configurations, or the activation of additional outlets, etc.). To address this, the system calibration controller 326 may operate in a dynamic feedback loop, continuously adjusting the position of the mixing valve 276 in real time or nearly real time to match the actual flow rate to the user's desired setting.

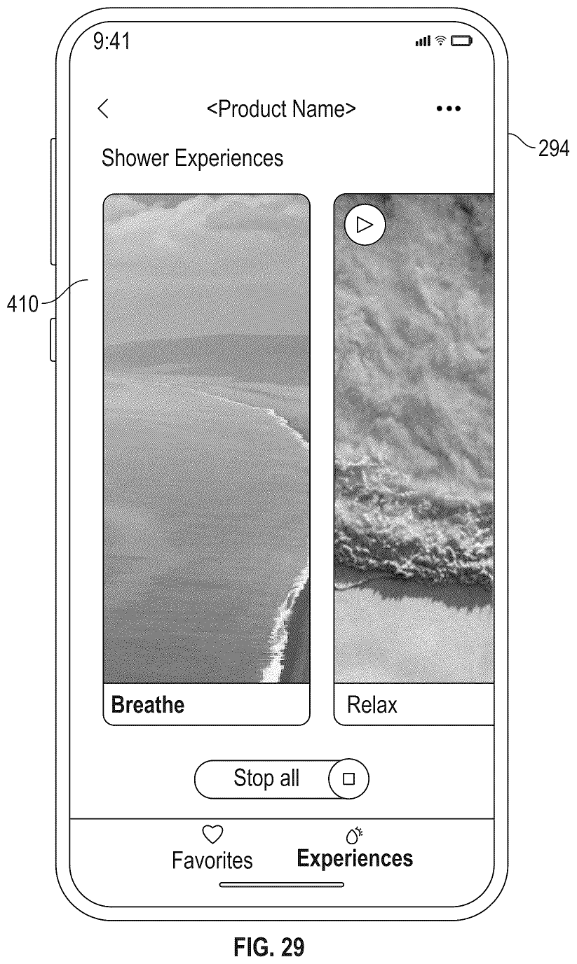

The memory 306 is shown to include an experience controller 328. The experience controller 328 may be configured to store recorded shower experiences and preprogrammed shower experiences. Each of the shower experiences may correspond to a particular sequence of outputs from the shower outlets 121-129, the steam outlets 131, the speakers 141, the lights 151, and/or the aromatherapy outlets 181. For example, some of the shower experiences may include dispensing water and/or steam from a predetermined combination of the shower outlets 121-129 and steam outlets 131 at a particular temperature for a particular duration. Some of the shower experiences may include multiple stages which are performed sequentially by the shower control system 200. Some of the shower experiences may include playing a particular audio track via the speakers 141 during the shower experience or coordinating audio effects with events that occur during the shower experience (e.g., transitioning between stages of the shower experience, starting steam emission, etc.). Some of the shower experiences may include lighting effects and/or aromatherapy effects that are coordinated with various stages of the shower experience and/or events that occur during the shower experience. It is contemplated that the shower experiences provided by experience controller 328 may include coordinated outputs from any or all of the shower subsystems 230-280. In other words, the shower experiences may include any combination of the different types of experiences or effects provided by the shower subsystems 230-280 (e.g., water experiences, steam experiences, aromatherapy experiences, audio experiences, lighting experiences, etc.). This concept is explored in greater detail with reference to the synchronization controller 330. A user can select a shower experience by selecting the corresponding graphical element via the control panel 160 or the shower experience GUI shown in FIG. 29.

The valve controller 324 may generate the control signals by comparing the current output of each the mixing valves 276 to a setpoint. The setpoint may be a user-defined setpoint provided via the network 290 or the control panel 160, or a programmed setpoint defined by a programmed shower experience or other automated feature. The current output may be measured by one or more sensors configured to measure the temperature and/or flow rate of the water dispensed one or more of the mixing valves 276. The valve controller 324 may use any of a variety of control techniques (e.g., proportional control, proportional-integral (PI) control, proportional-integral-differential (PID) control, model predictive control (MPC), pattern recognition adaptive control (PRAC), etc.) to determine an appropriate control signal for the mixing valves.

Each mixing valve 276 may be configured to affect the water dispensed from one or more water delivery devices. The valve controller 324 may use the stored water outlet configuration 314 to determine which the mixing valves 276 correspond to a set of water delivery devices for which an adjustment is required. The valve controller 324 may then provide the generated control signals to the determined the mixing valves 276 via the communications interface 344.

Memory 306 is shown to include a synchronization controller 330. In exemplary embodiments, the synchronization controller 330 may be configured to transmit communications to a lighting controller 332, an audio controller 336, and the valve controller 324. The synchronization controller 330 is configured to synchronize lighting output from the lighting system 250, audio output from the audio system 240, and spray pattern output from the mixing valves 276. In this way, the controller 260 may create a synchronized shower experience, in which the light output and water spray patterns are synchronized to audio, such as music or any other user selected audio sounds. The water outlets (e.g. 121-129) may have a spray pattern controllers that are the same or similar to the shower sprayer system described in U.S. patent application Ser. No. 17/241,764, filed Apr. 27, 2021, the entire disclosure of which is incorporated by reference herein.

Memory 306 is shown to include a lighting controller 332, a steam controller 334, an audio controller 336, and an aromatherapy controller 338. Controllers 334-338 may be similar to the valve controller 324 in that they provide the functionality used by controller 260 to control various types of output devices. For example, the lighting controller 332 may be configured to monitor and the control lighting system 250, the steam controller 334 may be configured to monitor and the control steam system 230, the audio controller 336 may be configured to monitor and the control audio system 240, and the aromatherapy controller 338 may be configured to monitor and control the aromatherapy system 280.

Controllers 334-338 may be configured to receive feedback signals from the systems 230-280 via communications interface 344 and to generate control signals for the systems 230-280. In some instances, the control signals are based on user-defined setpoints, or other user inputs provided via the network 290 or the control panel 160. For example, a user may provide an input to the control panel 160 to increase or decrease a steam temperature setpoint or to turn on/off a lighting fixture. In other instances, the control signals are based on a programmed control sequence stored in the memory 306 (e.g., a stored shower experience on the experience controller 328 or a recorded shower experience on an experience recorder 340). Controllers 334-338 may provide the generated control signals to the systems 230-280 via a communications interface 344. It is appreciated that the programmable features/settings disclosed herein are merely exemplary, and that additional programmable features associated with water delivery control may be included in the control architecture.

Memory 306 is shown to include an experience recorder 340. Experience recorder 340 is configured to record a sequence of changes to shower settings made by a user during a shower experience and store those changes at the memory 306. User inputs may be changes to temperature setpoint, turning on or off certain shower outlets at certain times, changing outlet spray pattern, starting aromatherapy, starting steam outputs, etc. User inputs may also be changes to the lighting system 250, the audio system 240, or an input to synchronize the systems thereto. Experience recorder 340 receives the sequence of changes to settings made by a user during the shower and creates a corresponding shower experience, according to exemplary embodiments. For example, the experience recorder 340 may log each user input (e.g., via buttons on the control panel 160, mobile device 294, etc.) and an associated timestamp. The experience recorder 340 may organize the logged data into structured formats, such as arrays or objects, for storage in memory 306. Each entry within the log may include parameters like the type of setting changed (e.g., temperature, outlet status, etc.), the specific value of the setting (e.g., 102° F., front showerhead 121 ON), and the timestamp. In some examples, the experience recorder 340 may export/transmit a data packet including each recorded experience to a connected app (e.g., Kohler Konnect) via the network 290 such that a user can access their recorded experiences remotely (e.g., from mobile device 294, non-mobile device 296, etc.).

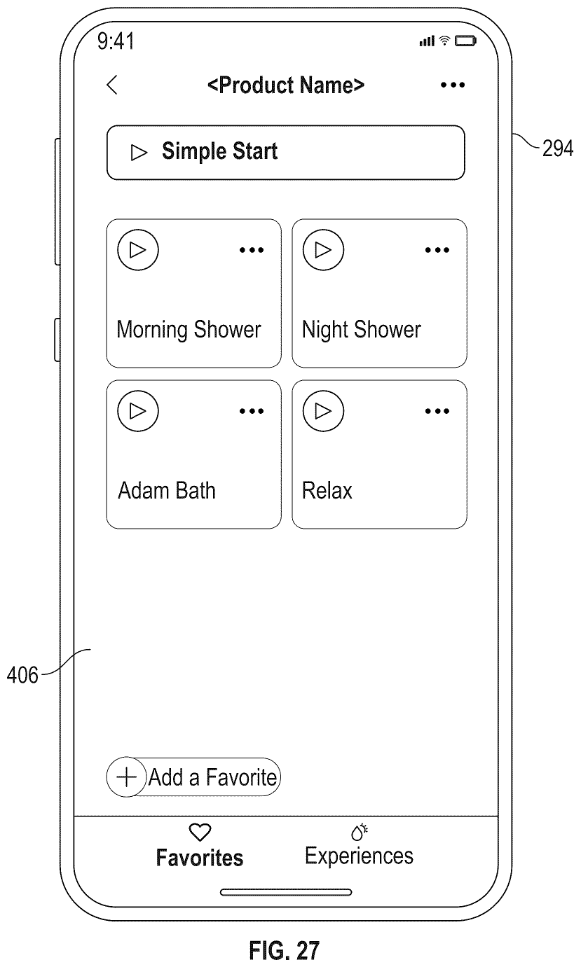

The experience recorder 340 may generate or update a GUI to displayed on the control panel 160 to include a user selectable option of a recorded shower experience. For example, the experience recorder 340 may cause the control panel 160 to display an icon or an image associated with a recorded experience. In some examples, the experience recorder 340 may prompt a user to name a recorded experience upon completion of the recording process. The icon, image, or user input name of the recorded shower experience may be transmitted to the connected app as a part of the data packet discussed above. For example, a user may name a recorded experience “Morning Shower” and may select a corresponding icon. The experience recorder 340 may cause the control panel 160 to display the user selected icon and may transmit the title to the connected app for display (see FIG. 27).

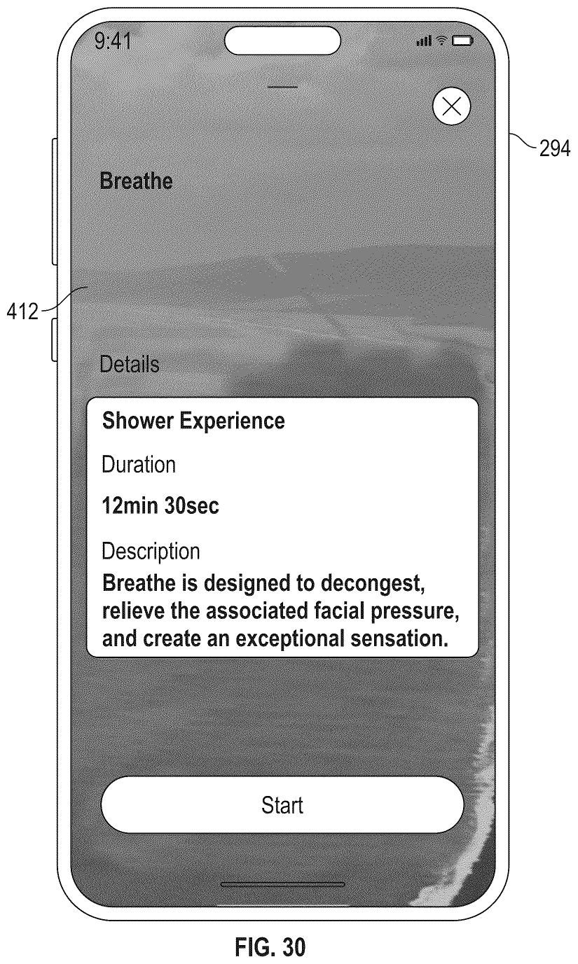

Referring now to FIG. 5, a flowchart of a purge process 500 is shown, according to an exemplary embodiment. Process 500 may be performed by the shower controller 260, or more specifically, by purge controller 316. At step 502, the shower controller 260 displays a graphical user interface that includes a menu of shower experience options (see FIGS. 29 and 30). This menu of shower experience options includes an option for a user to select a purge mode, which causes a purge cycle prior to their selected shower experience, according to exemplary embodiments. In exemplary embodiments, the user chooses a water temperature setpoint to begin their shower experience at. In other embodiments, a user's default shower temperature preference may be selected as the water temperature setpoint.

At step 504, the shower controller 260 enters a purge mode upon receiving a user input ordering a purge cycle. The input may be provided via a connected mobile device 294, the control panel 160, or another user interface. In the purge mode the shower controller 260 may identify mixing valves 276 and water delivery devices 278 that must be operated to perform a purge cycle. At step 506, the shower controller 260 transmits control signals to operate one or more water delivery devices 278 and/or mixing valves 276. For example, the shower controller 260 may transmit a signal to the mixing valves to open and intake hot and cold water according to a temperature setpoint.

At step 508, the shower controller 260 may retrieve water temperature data from one or more temperature sensors (e.g., disposed on or near the shower inlet pipes, integrated with the mixing valve 276, etc.). The shower controller 260 compares the temperature data to the temperature setpoint. If water temperature being dispensed through the water delivery device does not satisfy the temperature setpoint, the controller continues to operate the water delivery devices 278 and/or the mixing valves 276. In some examples, the shower controller 260 may transmit control signals to the mixing valves to adjust the intake of hot water and cold water based on the difference between the measured water temperature and the temperature setpoint. If the water temperature satisfies the water temperature setpoint, the shower controller 260 proceeds to step 510.

At step 510, the shower controller 260 pauses water flow through the water delivery devices 278 responsive to the water temperature satisfying the water temperature setpoint. The shower controller 260 may for example, close the mixing valves 276 to pause water flow through the water delivery devices 278. In other examples, the shower controller 260 may actuate additional devices within the shower 100, such as flow restrictors, stop valves, or other flow control devices, to pause the water flow through the water delivery devices 278.

At step 512, the shower controller 260 receives a second user input to start the shower after the purge cycle is complete. Responsive to receiving the second user input, the shower controller 260 may transmit control signals to operate the mixing valves 276 or other flow control devices to resume dispensing water through the water delivery devices 278.

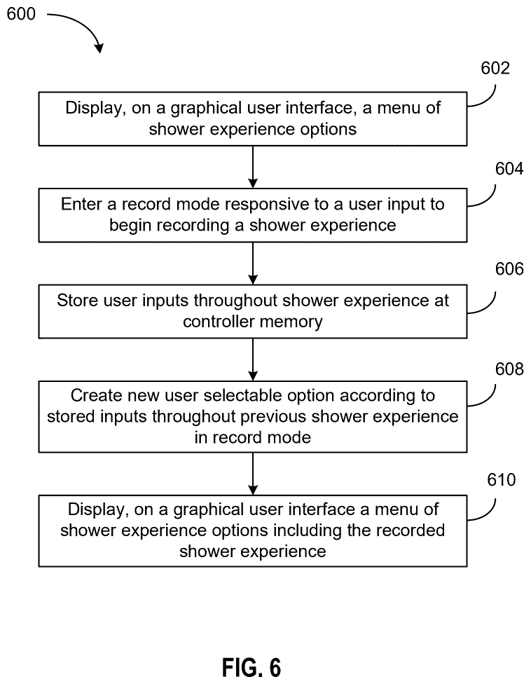

Referring now to FIG. 6, a flowchart of a process 600 is shown for recording a shower experience is shown, according to an exemplary embodiment. Process 600 may be performed by the shower controller 260, or more specifically, by the experience recorder 340. At step 602, the shower controller 260 displays, on a graphical user interface, a menu of shower experience options. Step 602 may be the same or substantially similar to step 502 in process 500 of FIG. 5. This menu of shower experience options includes an option to enter a record mode, according to exemplary embodiments.

At step 604, the shower controller 260 receives a user input (e.g., via the communications link, the communications interface 344, etc.) indicating that the user has selected a record experience option. A user may select the record experience option on the control panel 160 or on the mobile user device 294, for example.

At step 606, the shower controller 260 stores a sequence of settings based on user inputs throughout a shower experience at the controller memory 306, according to exemplary embodiments. User inputs may be changes to temperature setpoint, turning on or off certain shower outlets at certain times, changing outlet spray pattern, starting aromatherapy, starting steam outputs, etc. User inputs may also be changes to the lighting system 250, the audio system 240, or an input to synchronize the systems thereto. The controller 260 receives the sequence of changes to settings made by a user during the shower and creates a corresponding shower experience. The controller 260 may stop recording responsive to a second user input (e.g., via the control panel 160) or upon the user turning the shower 100 off.

After the recorded shower concludes, the controller 260 may create a new user selectable shower experience option corresponding to the recorded shower experience on the shower experience menu (steps 608, 610). For example, the recorder may store a user's inputted change from an initial 100° F. to 104° F. two minutes into the shower, an input to turn on a rainhead 128 five minutes into the shower, and an input to end the shower at ten minutes. After the shower experience concludes, the controller 260 may create and display a shower experience option corresponding the recorded shower experience. The user may later select this recorded option to start a ten-minute shower session that initially outputs water at 100° F., increases to 104° F. at two minutes, and activates the rainhead 128 five minutes into the shower session.

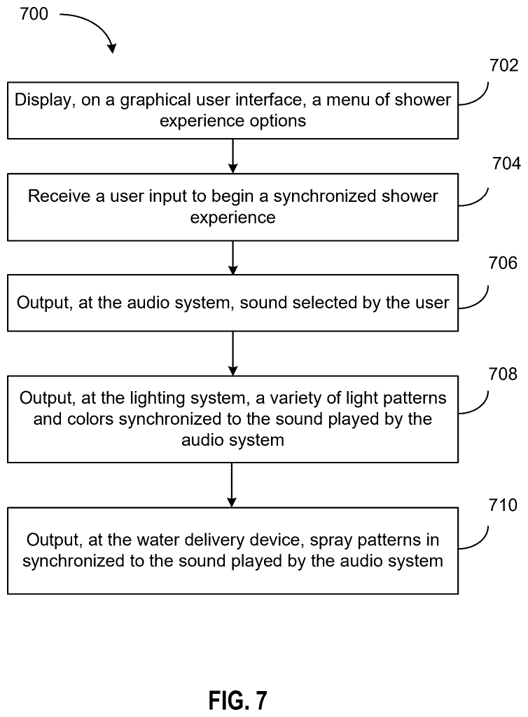

Referring now to FIG. 7, a flowchart of a synchronization process 700 is shown, according to an exemplary embodiment. The process 500 may be performed by the shower controller 260, or more specifically, by the synchronization controller 330. At step 702, the shower controller 260 displays, on a graphical user interface, a menu of shower experience options including a synchronized shower experience option. Step 702 may be the same or substantially similar to step 502 in process 500 of FIG. 5, and step 602 in process 600 of FIG. 6.

At step 704, the shower controller 260 receives user input indicating that the user has selected a synchronized shower experience (e.g., via the communication link, the communications interface 344, etc.). In some examples, preset shower experiences include synchronized sounds (e.g., music, white noise, etc.), light patterns and colors, and spray patterns output by the water delivery devices 278. In other examples, a user may choose to play a sound (e.g., music, white noise, etc.) via the audio system 240 and may choose to have the lights and/or the spray patterns synchronized with their selected sound.

At step 706, the shower controller 260 transmits control signals to operate the audio system 240 to output a user selected sound or a sound corresponding with a selected shower experience. At step 708, the shower controller 260 may transmit control signals to the lighting system 250 to output a variety of light patterns and colors that are synchronized with the sound played by audio system 240. The controller 260 may simultaneously operate the water delivery devices 278 (e.g., shower outlets 121-129) to output spray patterns that are synchronized with the sound played by audio system 240. In some examples, the shower controller 260 synchronizes light patterns, light colors, and spray pattern to the sound by performing frequency synchronization. For example, the shower controller 260 may analyze the sound frequencies or beats of the audio in real time, nearly real time, or based on pre-analyzed data. Changes in audio frequency, intensity, or beat pattern may serve to trigger an alternate light pattern or spray pattern.

In alternative embodiments, the sound output by the audio system 240 and water patterns output by the water delivery devices may by synchronized with the light output by the lighting system 250. In other embodiments, the sound output by audio system 240 and light output by the lighting system 250 may be synchronize with the water patterns output by the water delivery devices.

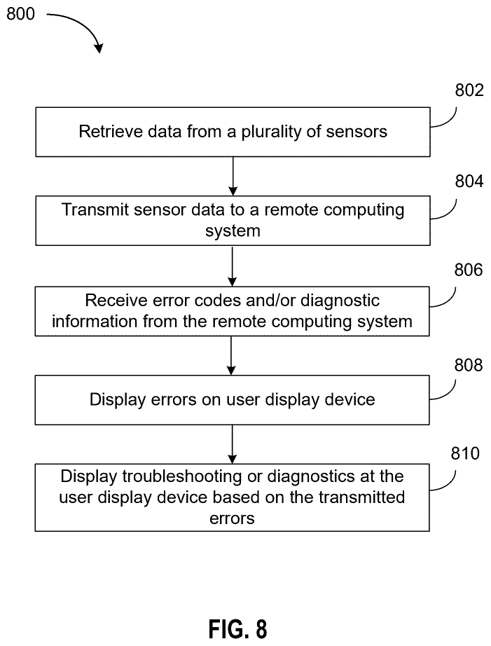

Referring now to FIG. 8, a flowchart of an error detection process 800 is shown, according to an exemplary embodiment. Process 800 may be performed by the shower controller 260, or more specifically, by the cloud integration controller 342 using the telemetric data 322 and the usage information 320. In exemplary embodiments, the mixing valves 276 include a variety of sensors such as temperature sensors and flow rate sensors. At step 802, the cloud integration controller 342 may retrieve data from the temperature sensors and flow rate sensors associated with the mixing valves 276. As discussed above, the cloud integration controller 342 may collect usage information 320 associated with user inputs. The cloud integration controller 342 may determine additional usage information 320 based on the sensor data. For example, the cloud integration controller 342 may calculate how many gallons of water were used over the course of a shower and transmit the calculated value to the remote computing system 298.

At step 804, the cloud integration controller 342 transmits the collected and measured data to remote computing system (i.e., a cloud computing system) via the network 290. In some examples, the remote computing system is associated with a provider or manufacturer of the shower 100. The remote computing system 298 may store a database of error codes corresponding to a variety of sensor data ranges and patterns that may indicate operational issues. The error codes may include classifications regarding the severity of an error. For example, a critical error may require a hard system reset (e.g., power cycle) to clear the error. A resettable error may be cleared without reset (e.g., by user input on a user device), and a warning error may indicate that operational parameters (e.g., temperature, flow rate, valve position, etc.) are outside of a preset “normal” range.

When data is received from the cloud integration controller 342, the remote system may compare the data against stored parameters to detect discrepancies or deviations indicative of an error condition. Additionally, remote computing system 298 may determine a device associated with the error condition. For example, if the temperature sensor data indicates a temperature that diverges from the expected range for a user's settings, the remote computing system 298 may assign an error code to a specific inlet valve within the shower 100.

Although the example above describes a remote computing system 298 detecting errors in particular devices and assigning associated error codes, it is contemplated that the shower controller 260 may similarly store a database of error codes. In such embodiments, the shower controller 260 may retrieve data from sensors associated with the shower system components and compare the data against stored error code thresholds or patterns. Upon detecting a condition that matches an error code within its local database, the shower controller 260 may assign the corresponding error code and log the error for subsequent reporting, either to the remote computing system 298 or directly to a user interface (e.g., the control panel 160, the mobile device 294, the non-mobile device 296, etc.).

The remote computing system 298 may further determine diagnostics, troubleshooting instructions, or notifications of necessary repairs. Upon identifying an error or abnormal condition, the remote computing system 298 can retrieve or generate specific troubleshooting steps, diagnostics, and/or repair recommendations for the detected error. For example, the troubleshooting steps, diagnostics, and/or repair recommendations may include guidance for recalibrating a sensor, inspecting particular water delivery devices 278, or performing routine maintenance tasks such as cleaning or replacing parts.

At step 806, the cloud integration controller 342 receives the determined error, diagnostics, troubleshooting instructions. At step 808, the cloud integration controller 342 causes a user display (e.g., the control panel 160, the mobile device 294, the non-mobile device 296) to display the detected error. For example, the cloud integration controller 342 may cause the user display to display the error code, a type of error, and/or a device associated with the error. Depending on the type of error and the severity of the error, the cloud integration controller 342 may proceed to step 810.

At step 810, the cloud integration controller 342 displays troubleshooting information, diagnostics, and/or repair recommendations on the user display (e.g., the control panel 160, the mobile device 294, the non-mobile device 296). For example, if an error is detected in one of the mixing valves 276, the display may show a diagnostic report detailing the affected component, the nature of the detected issue, and suggestions for resolving the error. Troubleshooting information may include by step by step instructions for resolving the detected error. For example, if a water temperature sensor is reporting values outside the acceptable range, the display may show instructions that walk a user through steps for recalibrating the sensor, checking for any obstructions, or contacting support services.

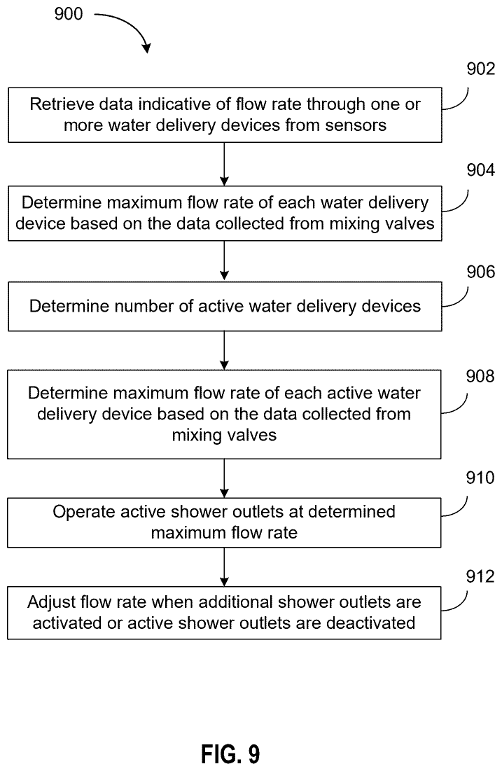

Referring now to FIG. 9, a flowchart of a calibration process 900 is shown, according to an exemplary embodiment. The calibration process 900 may be performed by the controller 260, or more specifically by the system calibration controller 326.

In exemplary embodiments, the mixing valves 276 and the pathway to each mixing valve's specific fitting (e.g., water delivery devices 278) include a variety of sensors such as temperature sensors and flow rate sensors. At step 902, the system calibration controller 326 retrieves sensor data indicative of the flow rate through a mixing valve 276 and an associated water delivery device 278.

At step 904, the system calibration controller 326 determines the maximum flow rate of each mixing valve 276 and associated water delivery device 121-129, 278 in shower 100 based on the measured flow rates. The maximum flow rate each shower outlet may vary based on plumbing setup, flow regulators, and outlet configurations specific to a shower 100. For example, the measured flow rates may be used as inputs for a data table that outputs a maximum flow rate for the particular mixing valve 276 and fitted water delivery device 278. For example, if a user sets a flow rate percentage for a particular shower outlet (e.g., 50%), the system calibration controller 326 would receive a measured flow rate delivered by the corresponding mixing valve 276. However, the physical position of the valve (e.g., being open 50%) does not necessarily correlate to 50% of the maximum flow rate (e.g., due to variations in water pressure, plumbing configurations, or the activation of additional outlets, etc.).

At step 906, the system calibration controller 326 may determine a number of water delivery devices 278 that are presently active during a shower experience. The system calibration controller 326 may, for example, determine the number of active water delivery devices 278 based on flow rate data associated with a particular water delivery device 278 or based on user input selecting a specific number of shower outlets. At step 908, the system calibration controller 326 may determine the maximum flow rate that may be outputted from each active water delivery device 278 based on the number of active water delivery devices 278.

In some examples, the system calibration controller 326 may convert user-defined flow rate percentages into precise absolute flow rates by referencing the maximum flow rate values it previously determined for each outlet. The system calibration controller 326 determines the absolute flow rate as a unit of volume per unit of time (e.g., gallons per minute, liters per minute, etc.). By way of example, if a shower experience includes settings like a 50% flow rate for a specific water delivery device 278, the system calibration controller 326 translates this percentage into an absolute flow rate value by scaling the percentage relative to the outlet's maximum capacity.

At step 910 the system calibration controller 326 may transmit control signals to the mixing valves 276 associated with the active water delivery devices 278. The system calibration controller 326 may cause the mixing valves 276 to adjust an outlet position to be more closed or more open relative to a default position. If the user activates additional shower outlets or deactivates shower outlets during a shower experience, the maximum flow rate of each active shower outlet is recalculated. For example, if a user deactivates a shower outlet, the unused flow capacity from the deactivated shower outlet may be allocated to the remaining shower outlets within the shower 100. In this way, the system calibration controller 326 determines a maximum range and scale of flow rates dynamically. At step 912, the system calibration controller 326 may transmit control signals to adjust the flow rates through the water delivery devices 278 according to the recalculated maximum flow rates as water delivery devices are activated and deactivated throughout a shower experience.

### Control Panel and User Interfaces

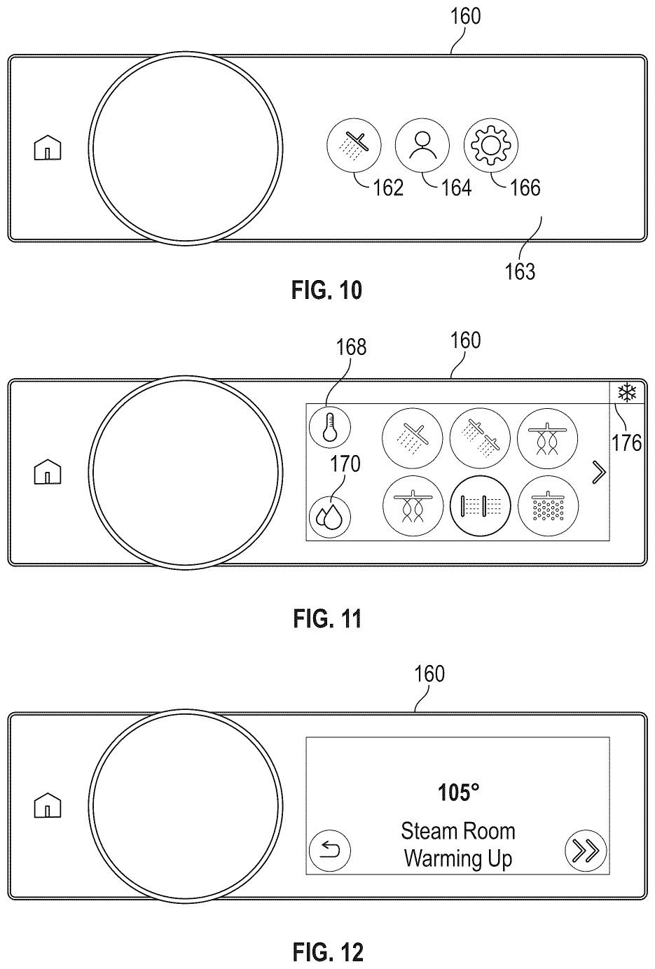

Referring now to FIG. 10, a front view of the control panel 160 displaying a default home screen is shown, according to an exemplary embodiment. In this embodiment, the control panel 160 includes touch-sensitive panel 163. The control panel 160 in combination with the touch-sensitive panel 163 comprise a user interface that allows the user to control the settings of the shower 100. This may include selection of shower experiences, shower outlets, temperature, and flow rate. Control panel 160 may be installed on the interior of the shower 100, according to exemplary embodiments. In other embodiments, control panel may be installed outside of the shower enclosure 110. The home or default screen of the control panel 160 may include a shower menu button 162, a user profile button 164, and a shower settings button 166. These buttons may be displayed on the touch-sensitive panel 163, according to exemplary embodiments. In alternative embodiments, the buttons may be hard key buttons or switches, or any combination of touch sensitive buttons, hard key buttons, or switches.

Referring now to FIG. 11, a front view of control panel 160 displaying shower outlet options is shown, according to an exemplary embodiment. The user may select the temperature button 168 to adjust their preferred water delivery temperature. The user may also select the flow control button 170 to adjust their preferred water delivery flow rate and pressure. In exemplary embodiments, the shower outlet menu includes buttons corresponding to the shower outlets installed in the shower 100. In this way, the user may select which shower outlets the user would like water delivered from by selecting an icon corresponding to the shower outlet's appearance. For example, a user may select a rainhead 128 and a middle body spray 125 on the control panel 160. In turn, the controller 260 transmits signals to mixing valves and delivers water at the desired water delivery devices 278 (e.g. shower outlets).

In some examples, the control panel 160 includes an option to activate a max cold mode, shown as a snowflake icon 176. A user may select the snowflake icon 176 to dispense cold water from the active water delivery devices 278. For example, responsive to a user selecting the snowflake icon 176, the controller 260 may operate the mixing valves 276 associated with the active water delivery devices 278 to inlet cold water only. In some embodiments, the max cold option includes a preset duration (e.g., 10 seconds, 15 seconds, 30 seconds, one minute, etc.). The preset duration may be a default duration or a user input duration. In other embodiments, the controller 260 operates the mixing valves 276 to inlet cold water as long as there is continuous user input on the snowflake icon 176 (e.g., as long as a button is depressed, as long as the user touches the icon, etc.).

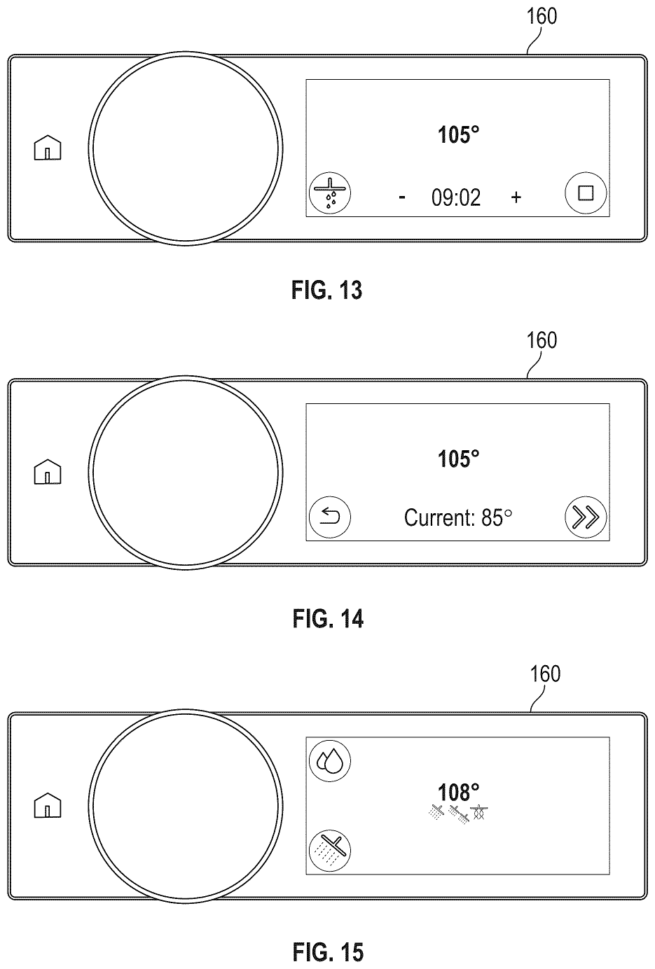

Referring now to FIGS. 12-14, front views of the control panel 160 displaying a steam room control user interface are shown, according to exemplary embodiments. Water delivery devices 278 may be paired with a steam adapter and steam generator to form a steam system, according to some embodiments. The steam system may further include a drain pan. In FIG. 12, a user has selected a steam room from a menu of shower experience options. The user may select a desired steam room temperature (e.g. 105 degrees) on the control panel 160. Control panel 160 may display an initial screen with the user inputted temperature setpoint and a button option to begin warming up the steam system. FIG. 13 shows a warmup user interface that may be displayed on the control panel 160 after a user selects the steam system warmup button shown in FIG. 12. The warmup user interface may display a countdown timer showing the user the amount of time the steam system will need to warm up before reaching the desired temperature setpoint. On this user interface, a user may adjust the temperature setpoint using the + and − buttons. Accordingly, the warm up countdown timer may be dynamically adjusted according to a user's changes to the desired temperature setpoint. FIG. 14 shows an alternative warmup user interface, displaying the desired temperature setpoint and the current temperature in the shower enclosure 110.

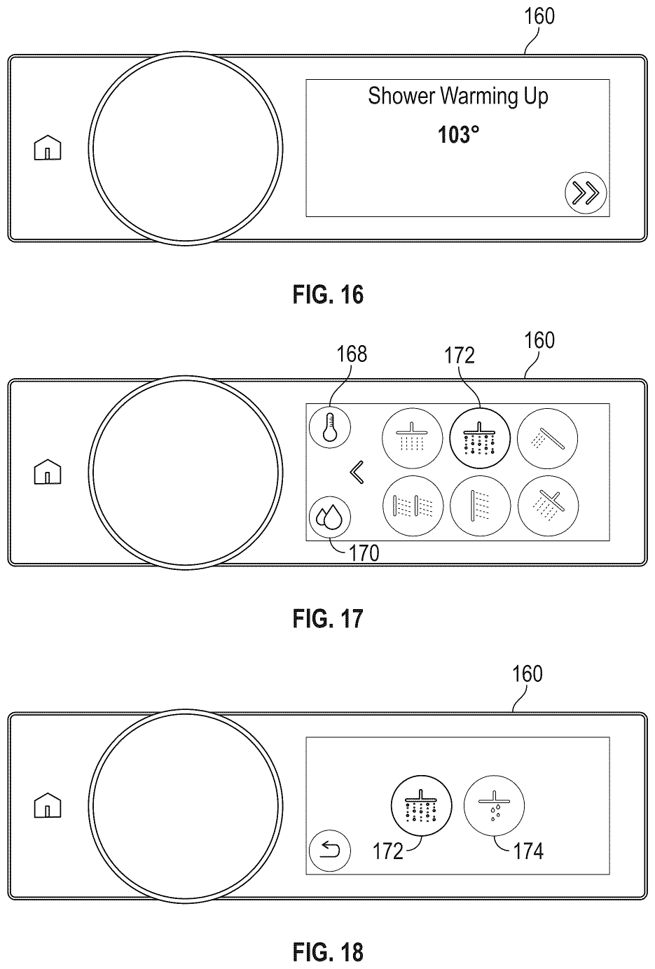

Referring now to FIG. 15 and FIG. 16, front views of control panel 160 displaying purge mode control user interfaces are shown, according to exemplary embodiments. As discussed with regards to process 500, a user may select purge mode from a menu of shower experience options displayed on the control panel 160. Once a user selects purge mode, FIG. 15 may be displayed on the control panel 160. The user may select their desired water outlet temperature and which shower outlets they would like to be purged. A user may also select “eco-mode,” which limits purging to one shower outlet and pauses water delivery when the desired water outlet temperature is reached, according to exemplary embodiments. Eco-mode is shown in greater detail in FIG. 25. After selecting the desired water outlet temperature for a set of shower outlets, the user interface shown in FIG. 16 may be displayed. FIG. 16 shows a purge warm up user interface, in which the measured water outlet temperature is displayed. When the desired water outlet temperature is reached, the control panel 160 may return to displaying FIG. 15.

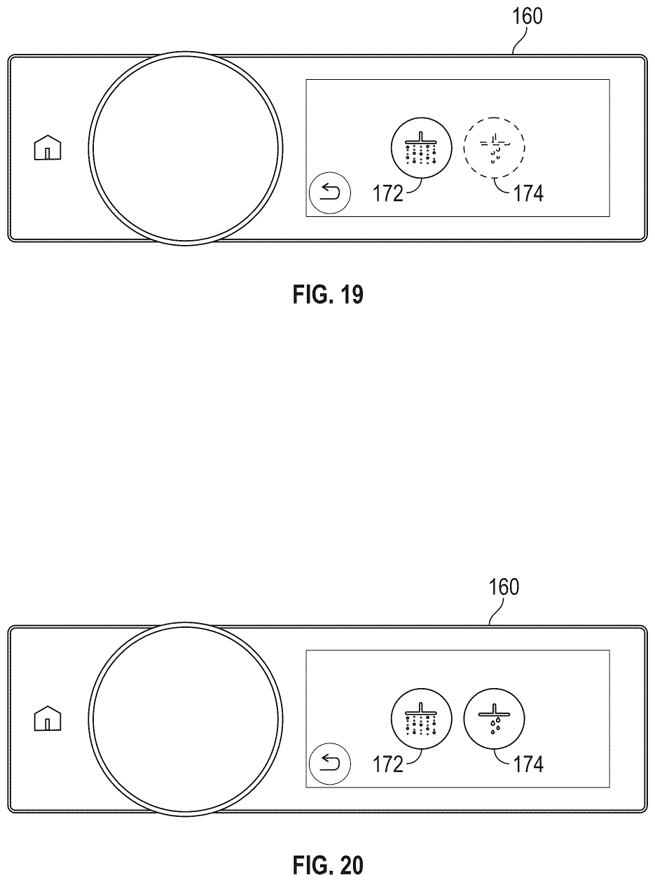

Referring now to FIGS. 17-20, showing front views of control panel 160 displaying deluge mode control user interfaces, according to exemplary embodiments. FIG. 17 shows that a user has selected the icon 172 associated with the rainhead 128. This causes the controller 260 to route water from an associated mixing valve 276 through the rainhead 128. In some examples, the controller 260 operates a drain to open and close such that the rainhead 128 fills a reservoir (e.g., a basin, a shower pan, a base, etc.) within the shower 100. FIGS. 18-20 shows a deluge button 174 that a user may select to drain the reservoir. As shown in FIG. 19 the deluge button 174 may be lit then unlit in a blinking pattern as the reservoir fills. When a user activates a deluge mode by selecting the deluge button 174, the reservoir is drained for a preset period of time (e.g. 5-15 seconds). Deluge mode may be activated by the user or may occur automatically when a sensor detects that the reservoir is full. After the deluge drain period, the deluge button 174 begins to blink again to indicate the reservoir in in the filling process.

### Setup, Updates, and Preferences

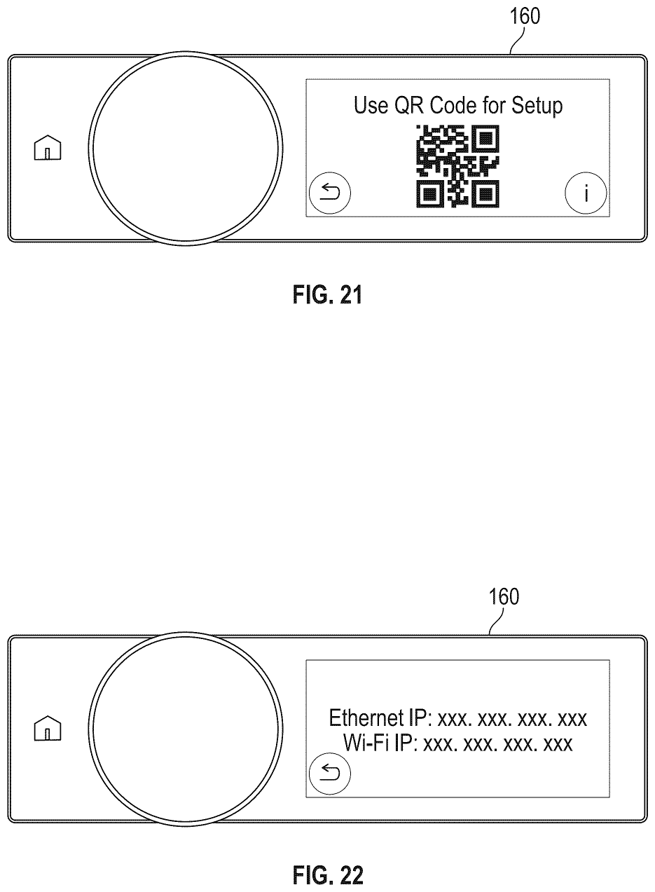

Referring now to FIG. 21 and FIG. 22, front views of control panel 160 displaying set up options are shown, according to exemplary embodiments. FIG. 21 shows control panel 160 displaying a setup user interface with a QR code than may be accessed by a mobile user device (e.g., mobile user device 294). In exemplary embodiments, a user scans the QR code with their mobile phone camera and accesses a setup webpage communicatively coupled with the network 290. FIG. 22 shows an alternative setup user interface displayed on the control panel 160. In this embodiment, a user may access a webpage using a displayed setup URL. The user may additionally couple the controller 260 via the control panel 160 to ethernet or Wi-Fi. The setup user interface may include a list of servers available on the home network to which the shower controller 260 is connected (e.g., via a router). The list of servers displayed in the setup user interface may be adjusted via a web interface or using the settings configuration options.

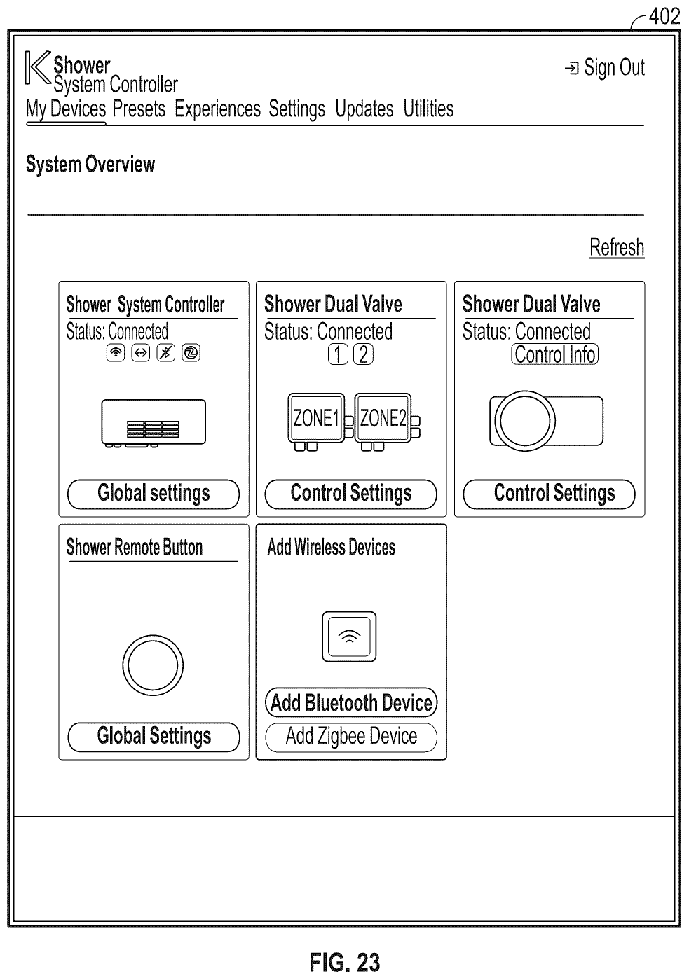

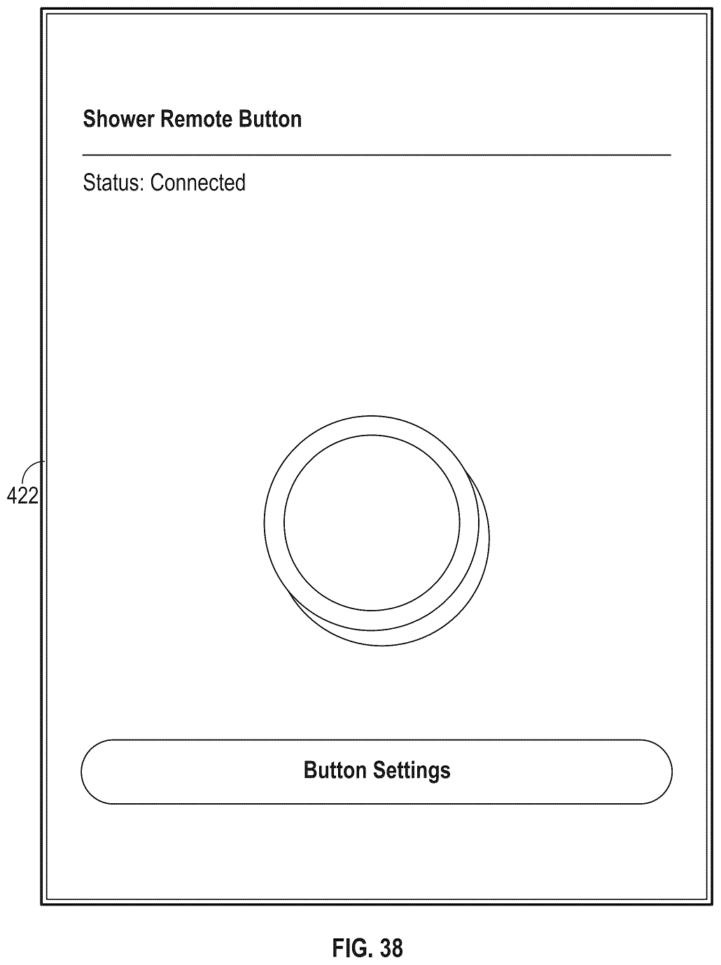

Referring to FIG. 23, an embedded shower system overview webpage 402 that may be displayed on mobile user device 294 is shown, according to an exemplary embodiment. This page may be used for initial shower setup, as shown in FIG. 12. A user may also access the embedded setup web page for a full list of settings that may be changed. For example, the shower controller 260 may include a wireless transceiver (e.g., Wi-Fi, Bluetooth, NFC, etc.) capable of communicating wirelessly with an external data source. In some embodiments, the shower controller 260 includes a Bluetooth-capable transceiver. A user can pair a Bluetooth-capable device (e.g., a smartphone, a portable music player, etc.) with the Bluetooth-capable transceiver to receive audio data from a Bluetooth audio source by adding a Bluetooth-capable device on the embedded setup page. The shower system overview webpage 402 may be used to access various other settings associated with a shower system. For example, a user may view the connectivity status of digital mixing valves (e.g., mixing valves 276), the connectivity status of control panel 160, the and the shower controller 260. The shower system overview webpage 402 is shown to include a widget for accessing a digital button for remotely turning the shower 100 on or off. The digital button is shown in greater detail in FIG. 38.

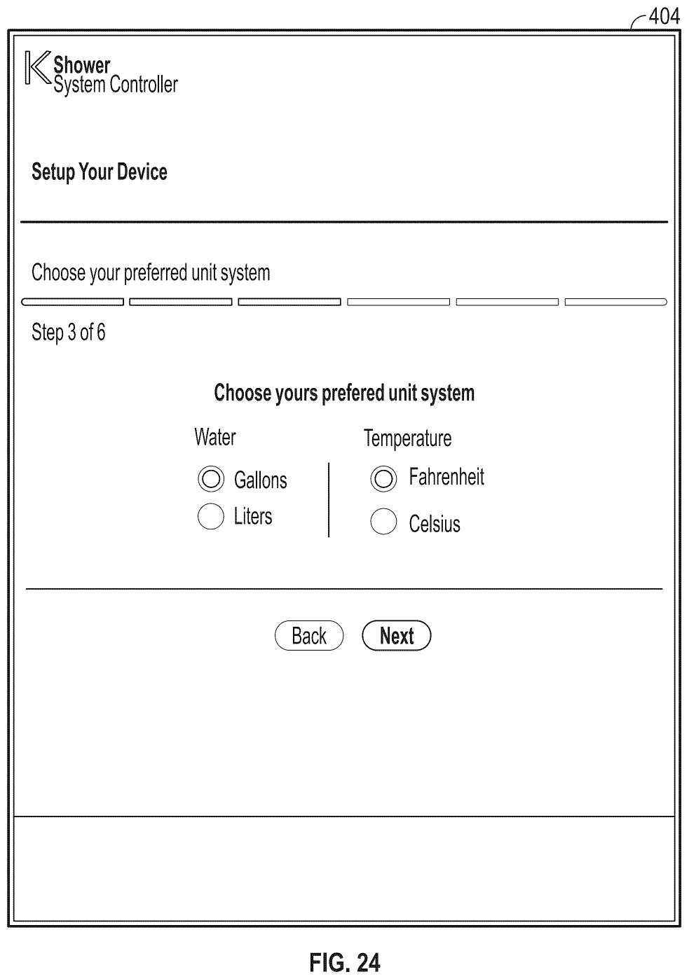

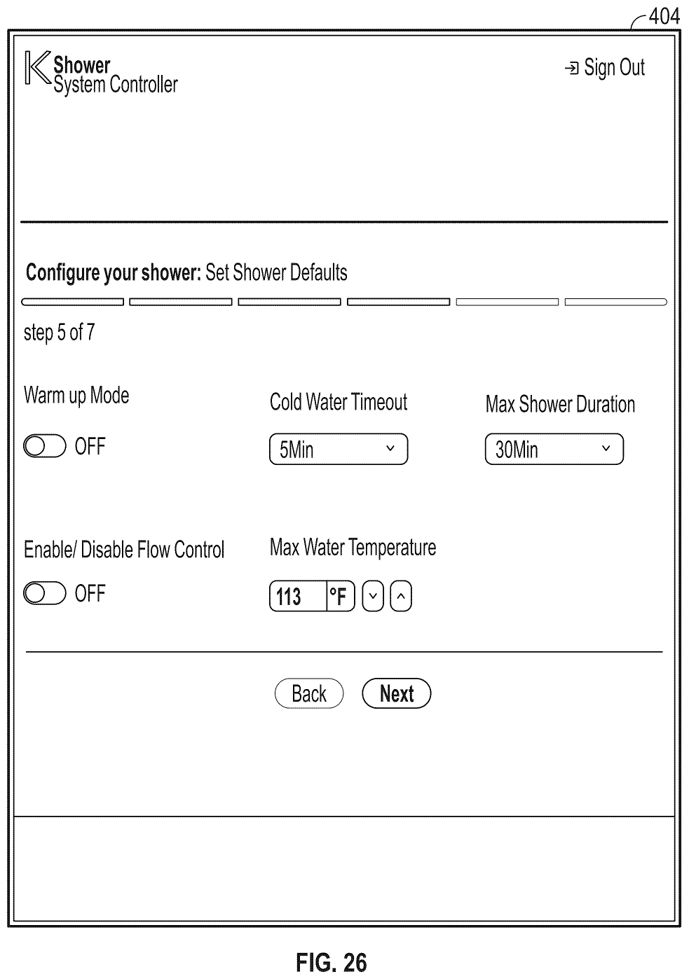

Referring to FIGS. 24-26, showing initial setup user interfaces on the embedded setup webpage 404, according to exemplary embodiments. FIG. 24 shows a preferred unit user interface that may be selected on the embedded setup webpage or automatically displayed on initial setup. On this user interface, a user is prompted select their preferred unit system (e.g., imperial unit system or metric unit system). The selected unit system selected will be used on control panel 160 when displaying temperatures and flow rates. FIG. 25 shows an eco-mode user interface, which may be selected on the embedded setup webpage or automatically displayed on initial setup. A user is prompted to select whether or not they are located in a low water flow region. For example, if the user lives in a place with regulatory limits on maximum flow rates for various water delivery devices. If this is the case, the user's system may automatically adjust output settings to operate in the most water efficient manner. This setting may be mandatory or changeable, according to exemplary embodiments. FIG. 26 shows a shower default setup user interface. In this user interface a user may select whether they would like warm up mode on or off, and for what duration of time the warm up mode should be able to run (e.g., 5 minutes). The user may also select whether flow control is enabled or disabled as an option displayed on control panel 160. The user may additionally select a maximum shower duration time and maximum water temperature.

Referring now to FIG. 27, a user interface 406 on the mobile user device 294 is shown, according to an exemplary embodiment. This page displays favorite preset shower experiences. For example, a user may select the pre-programmed “relax” shower experience and a recorded experience (e.g., “Adam Bath”) as favorite preset shower experiences. The controller 260 may create the preset favorite shower experience options and edited on control panel 160, according to some embodiments. In other embodiments, a user may create and edit preset favorite shower experiences on a mobile app. Preset favorite shower experiences can be activated using the control panel 160, a mobile app, or by voice command to a mobile device or home automation system.

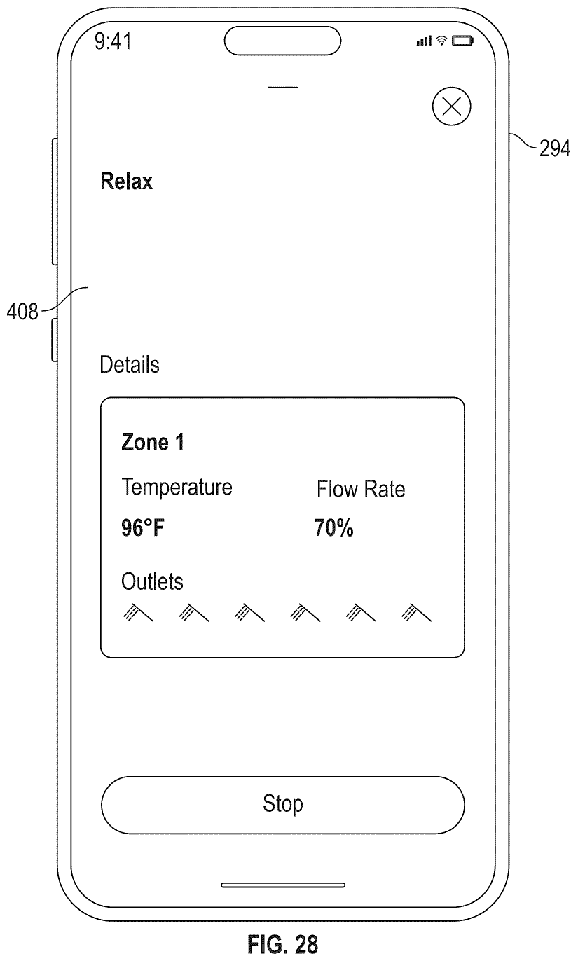

Referring now to FIG. 28, showing a user interface 408 of a user selected preset favorite shower experience, according to an exemplary embodiment. In this embodiment, a user has selected the “relax” experience from their preset favorite shower experience options. The user interface 408 is shown to include details regarding the temperature and flow rate associated with the selected shower experience. Additionally, the user interface 408 may detail which water delivery devices 278 are activated by the shower controller 260 during the selected shower experience. This GUI may be displayed on the mobile device 294 or on the control panel 160. The user may start or stop the selected experience on the GUIs shown in FIG. 27 and FIG. 28.

Referring now to FIG. 29 and FIG. 30, showing user interfaces 410, 412 of pre-programmed shower experiences, according to exemplary embodiments. These shower experiences utilize water outlets, steam, aromatherapy, light, and sound in a variety of combinations. Depending on the number of water outlets and specific shower configurations, certain pre-programmed shower experiences may be recommended on the user interface 410. For example, if a shower has three mixing valves, two shower outlets, and one steam outlet, the experiences that only utilize two or fewer shower outlets may be recommended. The user interface 412 shown in FIG. 30 displays the details of a shower experience a user selects from the menu shown on user interface 410 of FIG. 29. The user may choose to start their selected shower experience on the page shown in FIG. 30 or may exit and choose a different shower experience.

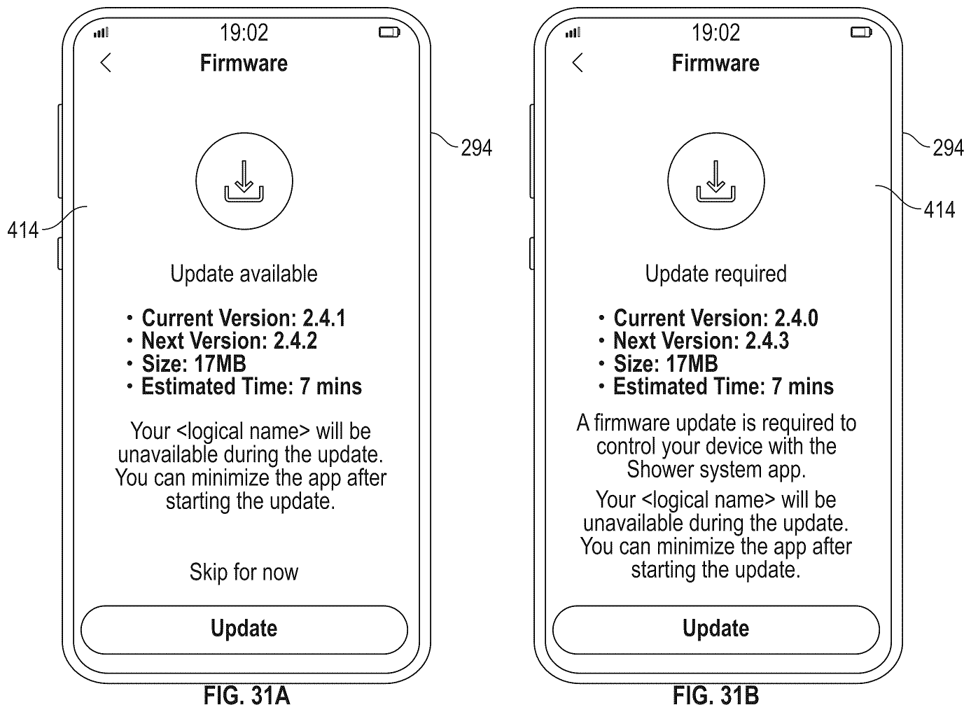

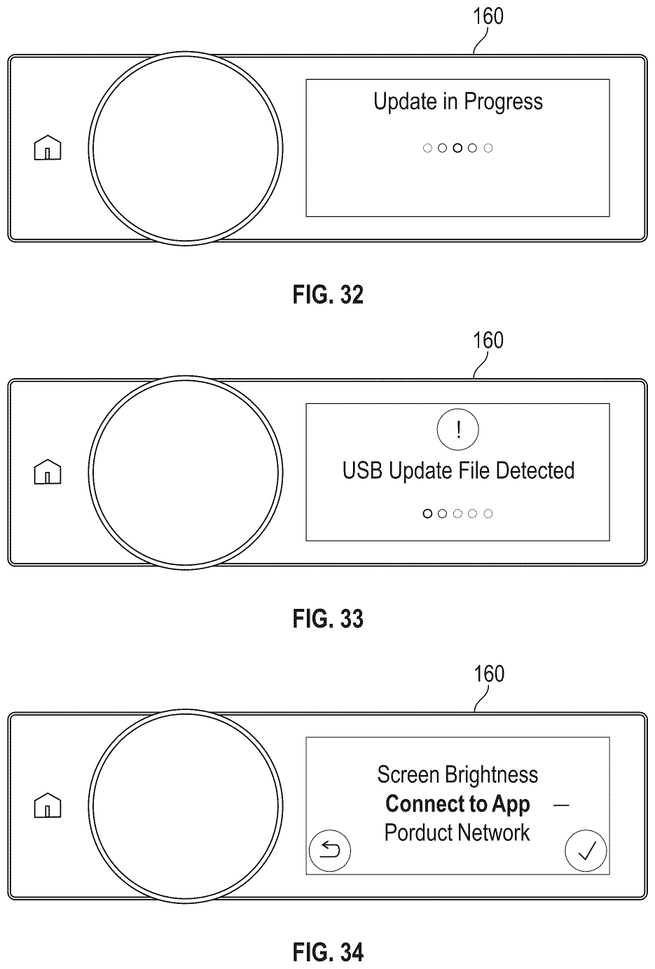

Referring now to FIGS. 31A-B and FIG. 32, showing Over the Air update user interfaces displayed on the control panel 160 and the mobile user device 294, according to exemplary embodiments. A user may choose to update their shower system on mobile user device 294 as shown in FIG. 31A and FIG. 31B. Updates may be required, as shown in FIG. 31B. In this case, the shower system may automatically update firmware on the shower controller 260 according to the required updates. Alternatively, a user may be prompted to make a required update on the control panel 160 and/or the mobile user device 294. Updates may also be optional, as shown in FIG. 31A. In this case, a user may be prompted with an update option for their shower system on control panel 160 or on a user interface 414 displayed on the mobile user device 294. FIG. 32 shows an update user interface displayed on the control panel 160. In this embodiment, a user may choose to update their system directly on the control panel 160. While the shower control system updates, the user interface shown in FIG. 32 may be displayed.

Referring now to FIG. 33, showing a USB update user interface on the control panel 160, according to an exemplary embodiment. In this embodiment, a user may plug a USB containing updated firmware files directly into the controller 260. Controller 260 may detect the USB drive, extract the firmware, and update the shower system accordingly. In other embodiments, when the controller 260 detects a USB drive, a user may be prompted on the control panel 160 to select what files should be extracted by the controller 260.

Referring now to FIG. 34, showing a mobile app connection user interface displayed on the control panel 160, according to exemplary embodiments. In exemplary embodiments, a user may select the shower settings button 166 on the default home screen of the control panel 160. On the settings menu, a user may choose to connect the shower controller 260 with an app corresponding to their shower system (e.g., Kohler Konnect). Once the controller 260 is connected to a mobile app, the controller may receive user inputs made on a mobile app via the mobile user device 294.

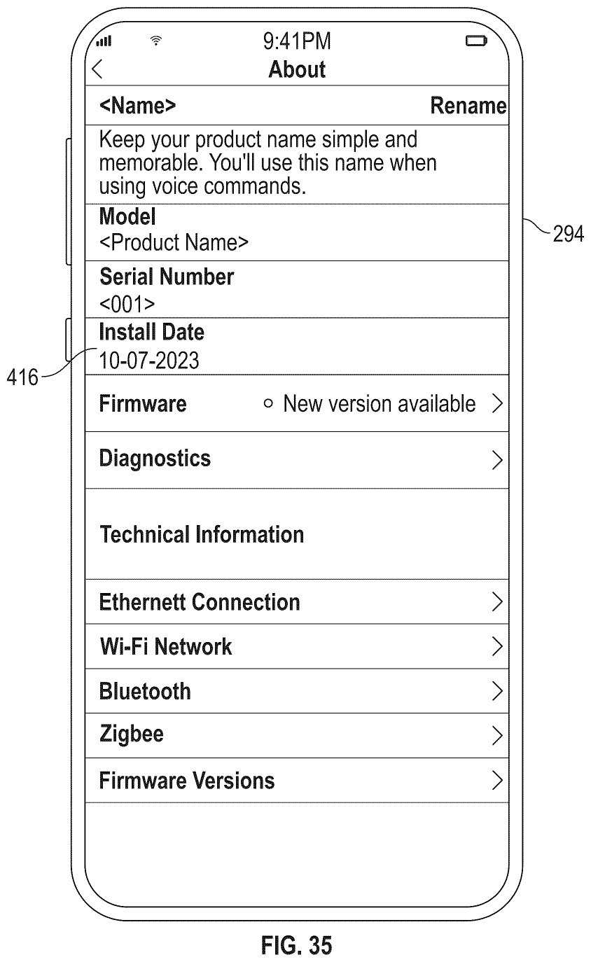

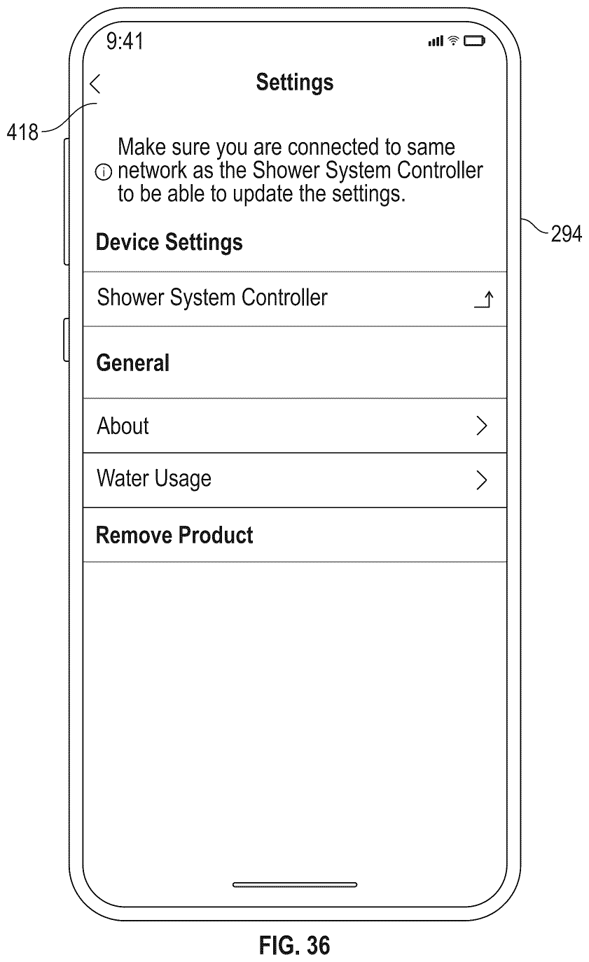

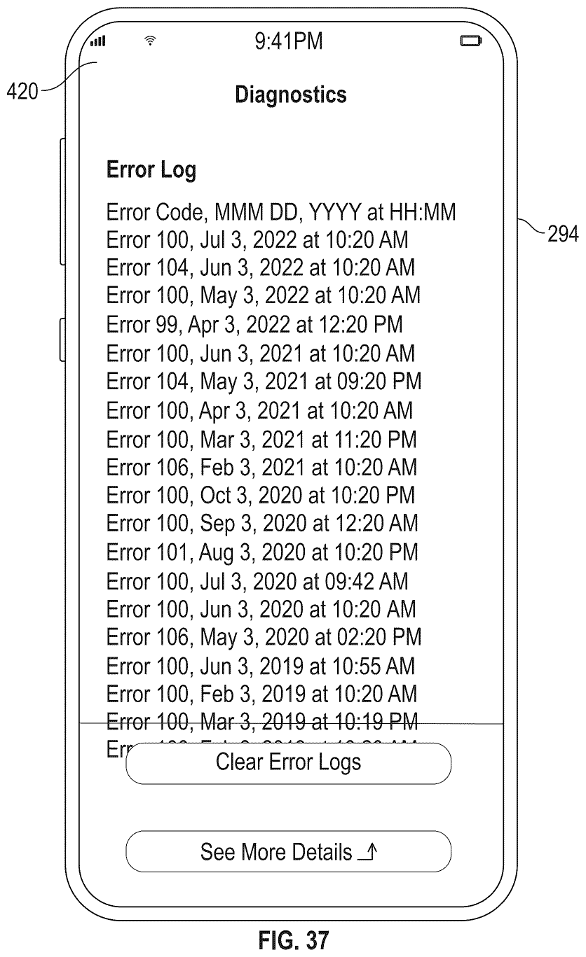

Referring now to FIGS. 35-38, showing user interfaces that may be accessed on a paired mobile app, according to an exemplary embodiment. FIG. 35 shows a user interface 416 that includes details related to the controller 260 including the firmware version, install date, and connected products. The user interface 416 may also display notifications of new firmware updates that are available at the time of user access. FIG. 36 shows a device settings user interface 418 on which a user may view their water usage, according to exemplary embodiments. Water usage (i.e., an amount of water usage) may include the volume of water used/dispensed in a shower experience, an average flow rate of water during a shower experience, a duration of use, and/or an energy consumption value. A user may also change what settings are displayed on control panel 160 by adjusting settings on the controller settings user interface 418. The mobile app may further include a diagnostic error user interface 420 that logs system errors, as shown in FIG. 37. The system error log user interface 420 allows users to report errors to servicers. These reports may inform future firmware updates for the shower control system.

Referring now to FIG. 38, showing a digital remote control button user interface 422 that may be integrated with the mobile app and accessed by the mobile user device 294, according to an exemplary embodiment. A user may start or stop their selected shower experience using the remote button the user interface 422, according to exemplary embodiments. Shower control system 200 may include a wireless transceiver (e.g., Wi-Fi, Bluetooth, NFC, etc.) capable of communicating wirelessly with an external data source. In some embodiments, shower control system 200 includes a Bluetooth-capable transceiver. A user can pair a Bluetooth-capable device (e.g., a smartphone, a portable music player, etc.) with the Bluetooth-capable transceiver to receive on/off data from associated with the remote button user interface 422.

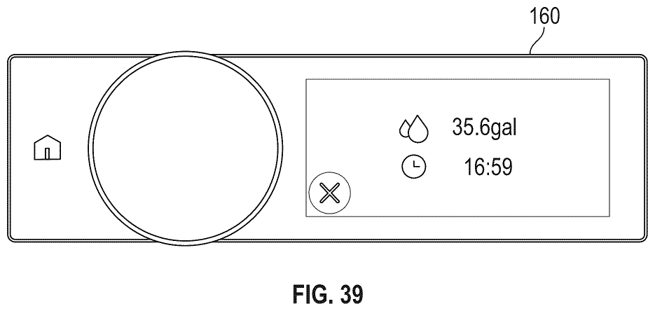

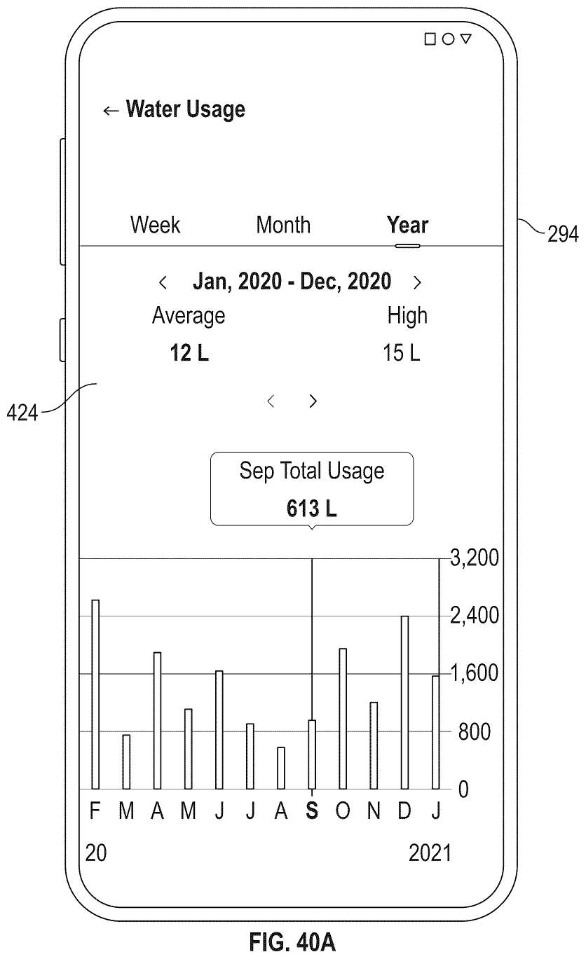

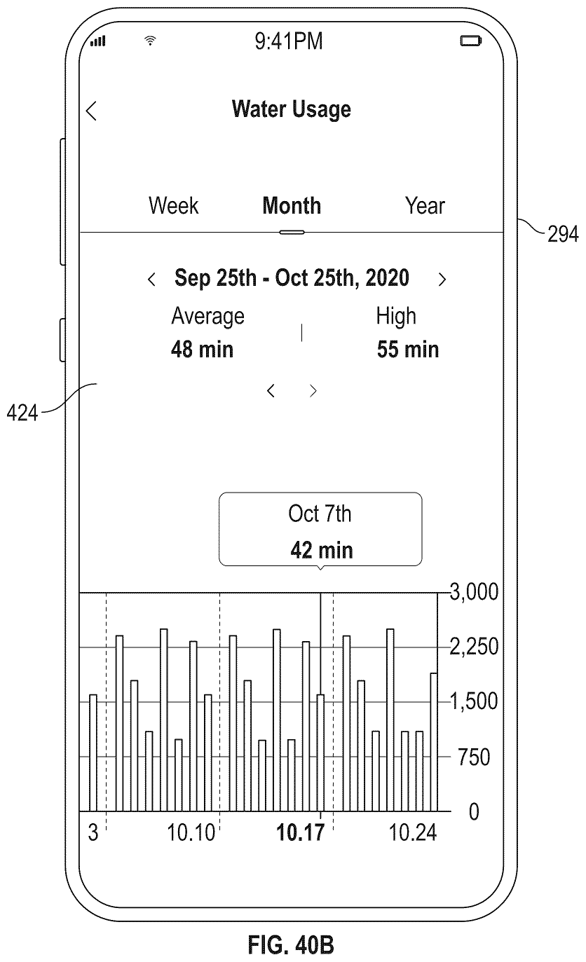

Referring now to FIG. 39 and FIGS. 40A-B, showing water usage reporting user interfaces on the control panel 160 and the mobile user device 294, according to exemplary embodiments. Water usage and shower duration may be displayed on the control panel 160 at the end of each shower, according to exemplary embodiments. In other embodiments, a user may access daily, weekly, monthly, and yearly water reports on control panel 160 in the settings menu. A user may also access user interface 424 that includes daily, weekly, monthly, and yearly water usage on an app accessed from the mobile user device 294. The user interface 424 may show average water usage by week, month, or year, as shown in FIG. 40A. In some examples, the user interface 424 includes average water flow rate by week, month, year, and/or all time. The user interface 424 may additionally or alternatively show the average shower duration or duration range, as shown on FIG. 40B. In some embodiments, the user interface 424 may include daily weekly, monthly, and yearly energy consumption by the shower control system 200.

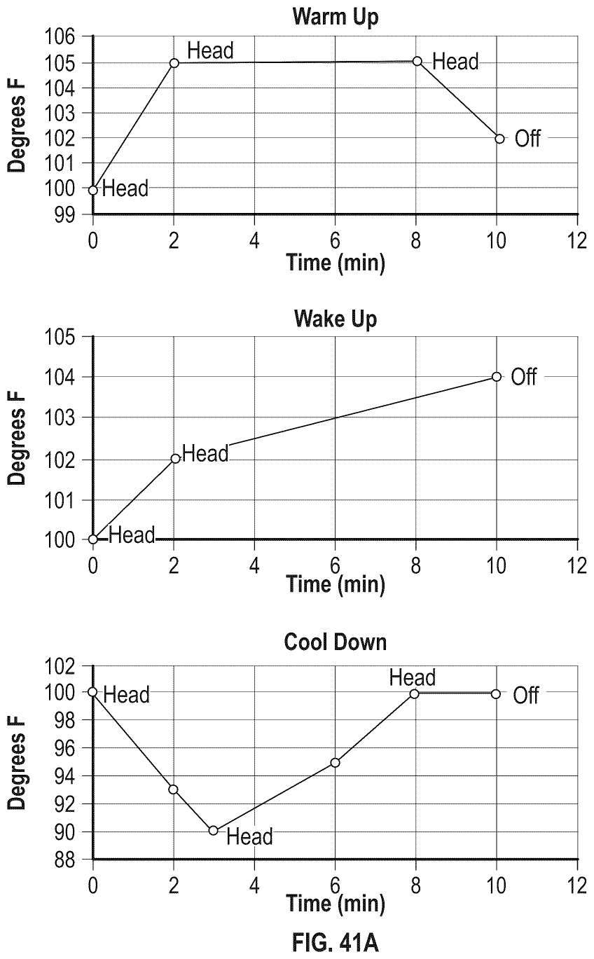

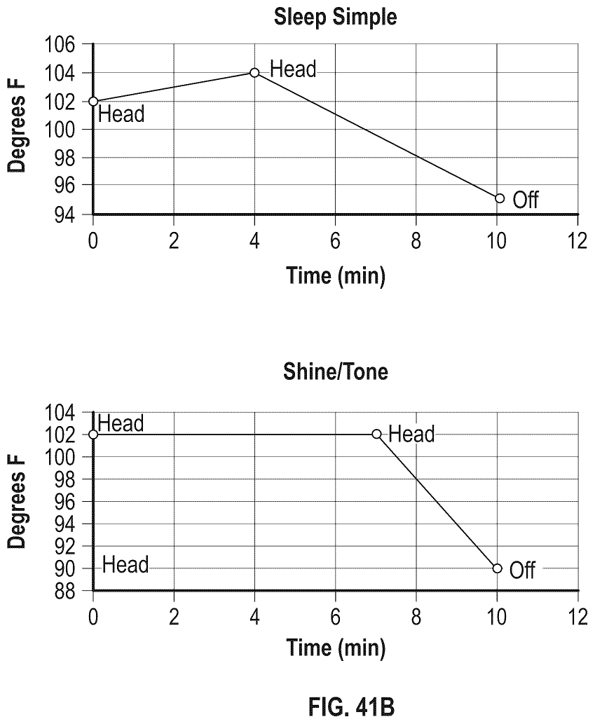

Referring now to FIGS. 41A-B, showing graphical representations of shower experiences controlled by controller 260, according to an exemplary embodiment. In exemplary embodiments, experiences may only use one outlet and may only use water (rather than steam, aromatherapy, etc.). In this way, the shower experiences are suited for low flow regions. On the graphs shown in FIG. 41A and 41B, each experience is shown using only the overhead showerhead. The x-axis of these graphs represent time, while the y-axis represents temperature. The experiences progress with temperatures changing to reach a temperature setpoint at a given time point. Experiences may have multiple stages with corresponding temperature setpoints. For example, the wake-up experience contains three temperature setpoints, while the cool down experience contains six temperature setpoints. Each stage has a predetermined duration that include a different combination of water outputs and output water temperatures.

### Valves

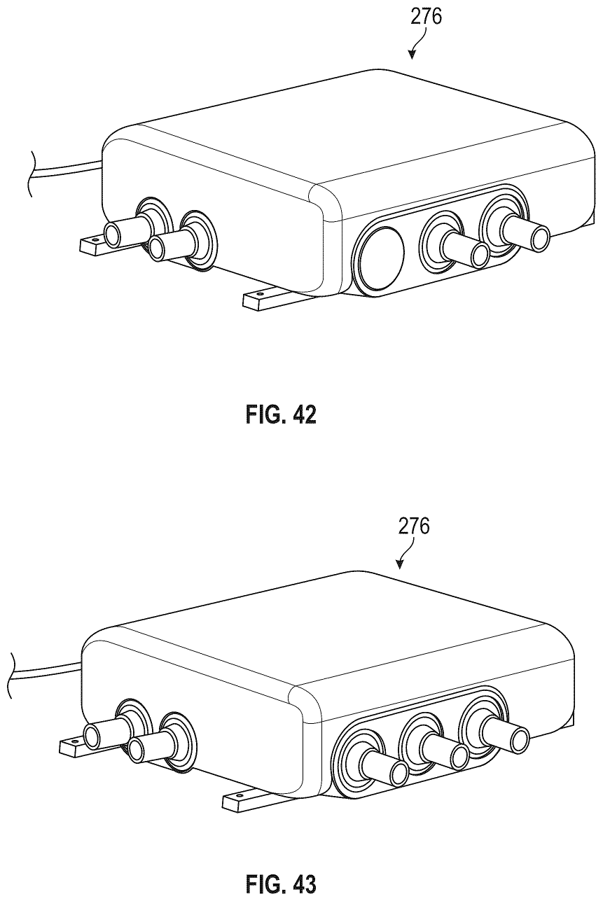

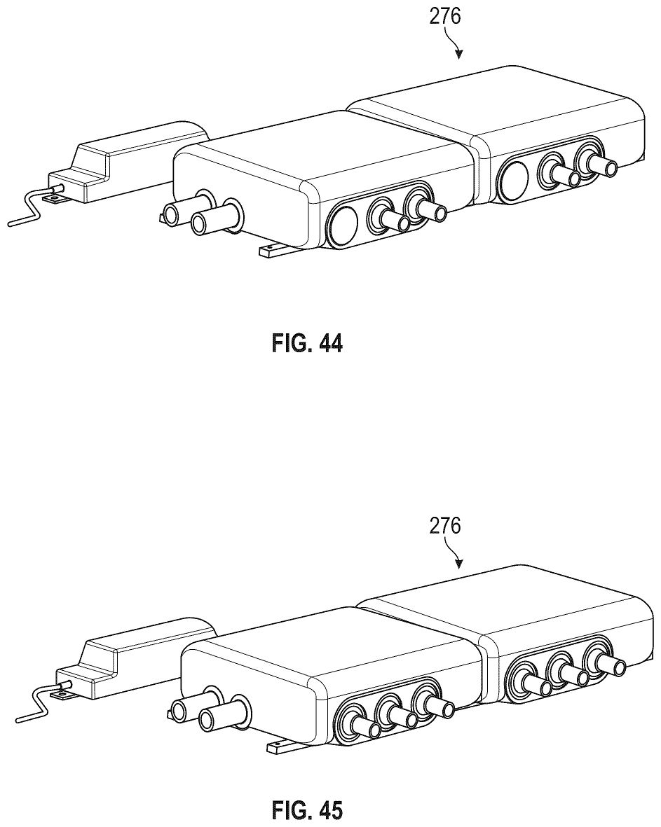

Referring now to FIGS. 42-45, showing perspective views of a variety of mixing valves 276, according to exemplary embodiments. These mixing valves may be implemented into the shower systems discussed in FIGS. 1-8, and 12-21. The mixing valves shown in FIGS. 42-45 may be installed into a shower system individually, or in combination. For example, two of the six outlet mixing valves shown in FIG. 45 may be installed to create a shower system with twelve or more water delivery devices.

As discussed above, mixing valves 276 may be communicatively coupled with the shower controller 260. For example, the mixing valves 276 may receive a control signal from the controller 260 that causes the mixing valves 276 to variably open or close to achieve a target water temperature and/or flow rate. In some embodiments, the mixing valves 276 include temperature sensors and/or flow rate sensors configured to measure the temperature and/or flow rate of the water dispensed by each of the mixing valves 276. In other embodiments, the sensors may be integrated with shower outlets 121-129 or otherwise located in the shower control system 200. The sensors may provide feedback to the controller 260 regarding the temperatures and/or flow rates of the water dispensed by each of the mixing valves 276. The shower controller 260 may use the feedback from the sensors in conjunction with one or more temperature and/or flow rate setpoints to determine an appropriate control signal for each of the mixing valves 276. The communications between the mixing valves 276, the controller 260, and the sensors may be wired or wireless, and may use any of a variety of communications protocols.

It is important to note that the construction and arrangement of the shower control systems and devices thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes, and omissions may also be made in the design, operating conditions and arrangement of the various exemplary embodiments without departing from the scope of the present invention.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members, or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The present disclosure contemplates methods, systems and program products on memory or other machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products or memory including machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A shower system comprising:
a water subsystem comprising one or more electronic valves configured to control a flow rate and a temperature of water dispensed from one or more shower outlets within a shower enclosure; and
a controller in communication with the water subsystem and configured to:
record a sequence of user inputs to adjust operation of the water subsystem while operating the water subsystem to dispense the water from the one or more shower outlets in accordance with the sequence of user inputs;
display a new shower experience option corresponding to the sequence of user inputs on a user display device; and
operate the water subsystem in accordance with the sequence of user inputs responsive to a user selecting the new shower experience option corresponding to the sequence of user inputs.

2. The shower system of claim 1, wherein the sequence of user inputs on the controller includes at least one of (a) a user input to change the temperature of the water dispensed from the one or more shower outlets, (b) a user input to change the flow rate of the water dispensed from the one or more shower outlets, or (c) a user input to activate or deactivate at least one of the one or more shower outlets.

3. The shower system of claim 1, wherein the controller is configured to calculate an amount of water usage while operating the water subsystem in accordance with the sequence of user inputs and display the amount of water usage upon completion of the sequence of user inputs.

4. The shower system of claim 1, wherein a user input of the sequence of user inputs causes the controller to enter a deluge mode, the deluge mode comprising:
operating an overhead showerhead to fill a reservoir; and
draining the reservoir responsive to detecting that the reservoir is full or according to preset increments of time.

5. The shower system of claim 1, wherein the controller is configured to record multiple sequences of user inputs and display multiple shower experience options, each of the shower experience options corresponding to a unique recorded sequence of the user inputs.

6. The shower system of claim 1 further comprising a control panel communicatively coupled to the controller, wherein the control panel is configured to display the new shower experience option corresponding to the sequence of user inputs.

7. The shower system of claim 1, wherein the controller is configured to transmit the sequence of user inputs to a mobile application communicatively coupled with the controller, wherein the mobile application is configured to display the new shower experience option corresponding to the sequence of user inputs.

8. The shower system of claim 1, wherein the controller is configured to execute a purge process comprising:
operating the water subsystem to dispense the water from the one or more shower outlets until the water reaches a temperature setpoint;
operating the water subsystem to pause dispensing the water from the one or more shower outlets when the water reaches the temperature setpoint; and
operating the water subsystem to dispense the water from the one or more shower outlets at the temperature setpoint in response to a user input.

9. The shower system of claim 1, wherein the controller is configured to:
display a prompt for user input indicating whether the shower system is located in a low flow region; and
in response to receiving the user input indicating the shower system is located in the low flow region, operate the water subsystem to limit a maximum flow rate of the water dispensed from the one or more shower outlets.

10. The shower system of claim 1, further comprising:
an audio subsystem configured to output audio from one or more audio output devices within the shower enclosure; and
a lighting subsystem configured to change lighting output of lighting devices within the shower enclosure;
wherein the controller is configured to:
record a second sequence of user inputs to adjust operation of the audio subsystem or the lighting subsystem in connection with the new shower experience option; and
operate the water subsystem, the audio subsystem, and the lighting subsystem in accordance with the sequence of user inputs to adjust operation of the water subsystem and the second sequence of inputs to adjust operation of the audio subsystem or the lighting subsystem responsive to the user selecting the new shower experience option.

11. The shower system of claim 10, wherein the controller is configured to operate the water subsystem, the audio subsystem, and the lighting subsystem simultaneously and in coordination with one another to provide a synchronized shower experience by concurrently executing both the sequence of user inputs to adjust operation of the water subsystem and the second sequence of inputs to adjust operation of the audio subsystem or the lighting subsystem.

12. A shower system comprising:
a water subsystem comprising one or more electronic valves configured to control a flow rate of water dispensed from a plurality of shower outlets within a shower enclosure;
one or more sensors configured to acquire data indicative of the flow rate of water dispensed from the plurality of shower outlets; and
a controller in communication with the water subsystem and the one or more sensors, the controller configured to:
determine maximum flow rates for each of the plurality of shower outlets based on the flow rate data;
convert a plurality of stored percentage flow rate values for the plurality of shower outlets into a plurality of absolute flow rate values for the plurality of shower outlets by scaling the percentage flow rate values to the maximum flow rates; and
operate the plurality of shower outlets in accordance with the absolute flow rate values when executing a stored shower experience.

13. The shower system of claim 12, wherein the one or more electronic valves are configured to modulate the flow rate independently for each of the plurality of shower outlets, thereby enabling individual control of the flow rate through each shower outlet.

14. The shower system of claim 12, wherein the controller is configured to:
receive a user input to decrease a flow rate of water dispensed from a first shower outlet of the plurality of shower outlets; and
allocate unused flow capacity from the first shower outlet to remaining shower outlets of the plurality of shower outlets.

15. A shower control system comprising:
a control panel configured to receive user inputs regarding adjustment to operation of one or more components of a shower system;
a plurality of sensors configured to measure operational data associated with the one or more components of the shower system; and
a cloud integration controller communicatively coupled to the plurality of sensors, wherein the cloud integration controller is configured to:
receive the operational data from the plurality of sensors;
receive the user inputs from the control panel;
transmit, via a network, the user inputs and the operational data to a remote computing system;
receive error information from the remote computing system; and
cause a display of the shower system to present the error information.

16. The shower control system of claim 15, wherein the remote computing system is configured to:
detect an error based on the operational data from the plurality of sensors and the user inputs from the control panel; and
identify a component of the one or more components of the shower system associated with the error.

17. The shower control system of claim 16, wherein the remote computing system is configured to generate one or more troubleshooting steps for resolving the error.

18. The shower control system of claim 17, wherein the cloud integration controller is configured to receive, from the remote computing system, the error information indicating the detected error, the component associated with the error, and the one or more troubleshooting steps for resolving the error.

19. The shower control system of claim 15, wherein the control panel includes a user display and the cloud integration controller is configured to cause the user display of the control panel to display the error information.

20. The shower control system of claim 15, wherein the operational data includes at least one of (a) water flow rate, (b) water temperature, or (c) connectivity status.
